(19) United States
(12) Patent Application Publication
(10) Pub. No.: US 2017/0016721 A1
(43) Pub. Date: Jan. 19, 2017

(54) DETERMINATION SYSTEM, DETERMINATION METHOD, AND NON-TRANSITORY COMPUTER READABLE MEDIUM

(71) Applicant: FUJI XEROX CO., LTD., Tokyo (JP)

(72) Inventors: Junya HANADA, Kanagawa (JP); Toshihiro NUMAUCHI, Kanagawa (JP); Masanori YOSHIZUKA, Kanagawa (JP)

(73) Assignee: FUJI XEROX CO., LTD., Tokyo (JP)

(21) Appl. No.: 15/016,848

(22) Filed: Feb. 5, 2016

(30) Foreign Application Priority Data
Jul. 15, 2015 (JP) 2015-141556

(51) Int. Cl. G01B 21/28

(52) U.S. Cl. CPC G01B 21/28

(57) ABSTRACT

A determination system determining a measurement standard includes a memory that stores information concerning a three-dimensional shape of a produced workpiece and the measurement standard set in a surface forming the workpiece in response to a location where the workpiece is supported when a length of the workpiece is measured, a calculating unit that calculates, in a projection plane perpendicular to a line normal to the surface having the measurement standard set thereon, an area of a first region based on an external shape of a projection image of the entire workpiece, and an area of a second region based on only a projection image of the surface having the measurement standard set thereon, and a determining unit that determines that the measurement standard is appropriate if a magnitude of the area of the second region to the area of the first region is higher than a predetermined threshold value.

### CROSS-REFERENCE TO RELATED APPLICATIONS

This application is based on and claims priority under 35 USC 119 from Japanese Patent Application No. 2015-141556 filed Jul. 15, 2015.

### Background

(i) Technical Field

The present invention relates to a determination system, a determination method, and a non-transitory computer readable medium.

(ii) Related Art

Design support systems, including a three-dimensional computer aided design system, have been used to design a component forming a mechanical workpiece.

### Summary

According to an aspect of the invention, there is provided a determination system that determines a measurement standard. The determination system includes a memory that stores information concerning a three-dimensional shape of a produced workpiece and the measurement standard that is set in a surface forming the workpiece in response to a location where the workpiece is supported when a length of the workpiece is measured, a calculating unit that calculates, in a projection plane perpendicular to a line normal to the surface having the measurement standard set thereon, an area of a first region that is based on an external shape of a projection image of the entire workpiece, and an area of a second region that is based on only a projection image of the surface having the measurement standard set thereon, and a determining unit that determines that the measurement standard is appropriate if a magnitude of the area of the second region to the area of the first region is higher than a predetermined threshold value.

### BRIEF DESCRIPTION OF THE DRAWINGS

Exemplary embodiments of the present invention will be described in detail based on the following figures, wherein:

FIG. 1 generally illustrates a design support system of a first exemplary embodiment of the present invention;

FIG. 2A and FIG. 2B are functional block diagrams illustrating functions of controllers in a client personal computer and a license server of the first exemplary embodiment;

FIG. 3 is an image of a workpiece displayed on a display of the first exemplary embodiment;

FIG. 4A and FIG. 4B illustrate the shape of a workpiece as a setting target of datum and a projection plane of the workpiece in accordance with the first exemplary embodiment, more specifically, FIG. 4A illustrates the projection plane on which the image of the entire workpiece is projected, and FIG. 4B illustrates the projection plane on which the datum is projected;

FIG. 5A and FIG. 5B illustrate projection images of the first exemplary embodiment of the present invention, more specifically, FIG. 5A illustrates the entire projection image, and FIG. 5B illustrates the projection image of the datum;

FIG. 6A through FIG. 6C illustrate an extraction process of outer periphery points in accordance with the first exemplary embodiment of the present invention, more specifically, FIG. 6A illustrates the extraction process to extract a start point, FIG. 6B illustrates the extraction process to extract an outer periphery point subsequent to the extracted start point, and FIG. 6C illustrates the extraction process to extract an outer periphery point subsequent to the extracted outer periphery point;

FIG. 7 is a flowchart illustrating a process of a design support program of the first exemplary embodiment of the present invention;

FIG. 8 is a flowchart illustrating a subroutine represented by ST6 of FIG. 7 as an input process of the datum in accordance with the first exemplary embodiment of the present invention;

FIG. 9 is a flowchart illustrating a subroutine represented by ST8 of FIG. 7 as a determination process of the datum in accordance with the first exemplary embodiment of the present invention;

FIG. 10 is a flowchart illustrating a subroutine represented by ST205 of FIG. 9 as a setting process of an entire region in accordance with the first exemplary embodiment of the present invention;

FIG. 11 is a flowchart illustrating a subroutine represented by ST207 of FIG. 9 as a setting process of a datum region in accordance with the first exemplary embodiment of the present invention;

FIG. 12A through FIG. 12C illustrate an operation of the first exemplary embodiment, more specifically, FIG. 12A illustrates a three-dimensional shape of a workpiece as a setting target of the datum, FIG. 12B illustrates an example of the datum that is set in a surface by the unit of surface, and FIG. 12C illustrates an example of the datum that is set in part of a surface;

FIG. 13A through FIG. 13D illustrate the operation of the first exemplary embodiment performed on the datum of FIG. 12B, more specifically, FIG. 13A illustrates a projection plane of the workpiece, FIG. 13B illustrates an entire region, FIG. 13C illustrates a datum region, and FIG. 13D illustrates an area ratio of the datum region to the entire region;

FIG. 14A through FIG. 14D illustrate the operation of the first exemplary embodiment performed on the datum of FIG. 12C, more specifically, FIG. 14A illustrates the projection plane, FIG. 14B illustrates the entire region, FIG. 14C illustrates the datum region, and FIG. 14D illustrates the area ratio of the datum region to the entire region;

FIG. 15A through FIG. 15D illustrate the operation of the first exemplary embodiment, more specifically, FIG. 15A illustrates an example in which the datum is appropriate, FIG. 15B illustrates an area ratio in FIG. 15A, FIG. 15C illustrates an example in which the datum is not appropriate, and FIG. 15D illustrates the area ratio in FIG. 15C;

FIG. 16A and FIG. 16B illustrate the area ratio of the areas set in the method of the first exemplary embodiment and the area ratio of the areas set in another method, more specifically, FIG. 16A illustrates the areas set in the method of the first exemplary embodiment, and FIG. 16B illustrates the area of an external shape with maximum dimensions;

FIG. 17A and FIG. 17B illustrate the area ratio of the areas set in the method of the first exemplary embodiment and the area ratio of the areas set in another method, more specifically, FIG. 17A illustrates the areas set in the method of the first exemplary embodiment, and FIG. 17B illustrates a projection area;

FIG. 18A and FIG. 18B correspond to FIG. 2A and FIG. 2B of the first exemplary embodiment and illustrate functional block diagrams of functions of controllers of a client personal computer and a license server of a second exemplary embodiment;

FIG. 19 is a flowchart corresponding to the flowchart of FIG. 9, and illustrating a determination and setting process of the datum in accordance with the second exemplary embodiment; and

FIG. 20A through FIG. 20D illustrate the operation of the second exemplary embodiment, more specifically, FIG. 20A illustrates the input datum, FIG. 20B illustrates the area ratio in FIG. 20A, FIG. 20C illustrates an additional datum, and FIG. 20D illustrates the area ratio in FIG. 20C.

### DETAILED DESCRIPTION

Exemplary embodiments of the present invention are described with reference to the drawing. The present invention is not limited to the exemplary embodiments.

In the following discussion with reference to the drawings, elements other than those that help understand the present invention are omitted in the drawings.

### First Exemplary Embodiment

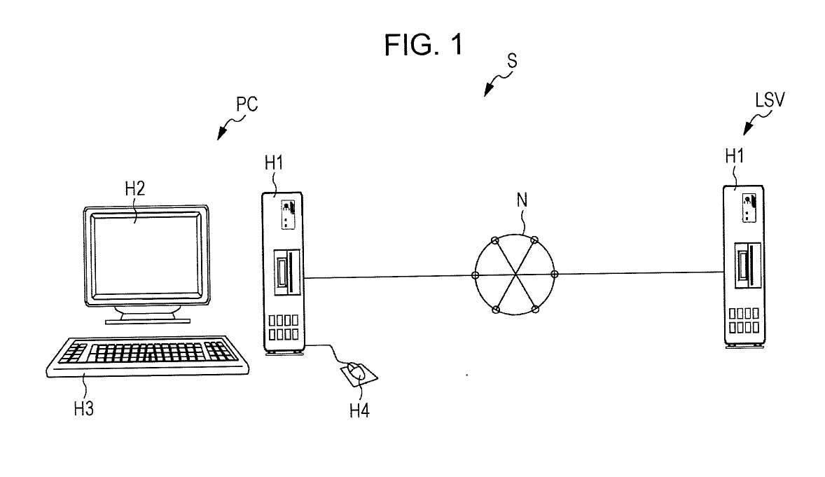

FIG. 1 generally illustrates a design support system S of a first exemplary embodiment of the present invention.

Referring to FIG. 1, the design support system S of the first exemplary embodiment has a function of a datum determination system that serves as a determination system of a measurement standard. The design support system S includes a client personal computer PC as an example of a design support apparatus. The client personal computer PC has a function of a determination apparatus of a measurement standard. The client personal computer PC is connected to a license server LSV, serving as an example of a licensing apparatus, via a network N serving as a communication network. The license server LSV grants an authorized client personal computer PC a license to use the design support system S. The network N of the first exemplary embodiment includes the Internet. Each of the client personal computer PC and the license server LSV in the first exemplary embodiment may include a computer.

The client personal computer PC of the first exemplary embodiment includes a computer body Hl. The computer body H1 connects to a display H2 serving as a display device. The computer body H1 also connects to a keyboard H3 and a mouse H4 serving as examples of input devices. The computer body H1 includes a hard disk (HD) drive (not illustrated) as an example of a memory, or a compact disk (CD) drive as an example of a reading device of a storage medium. Like the client personal computer PC, the license server LSV of the first exemplary embodiment includes a computer body H1 and a hard disk drive (not illustrated) or a CD drive (not illustrated).

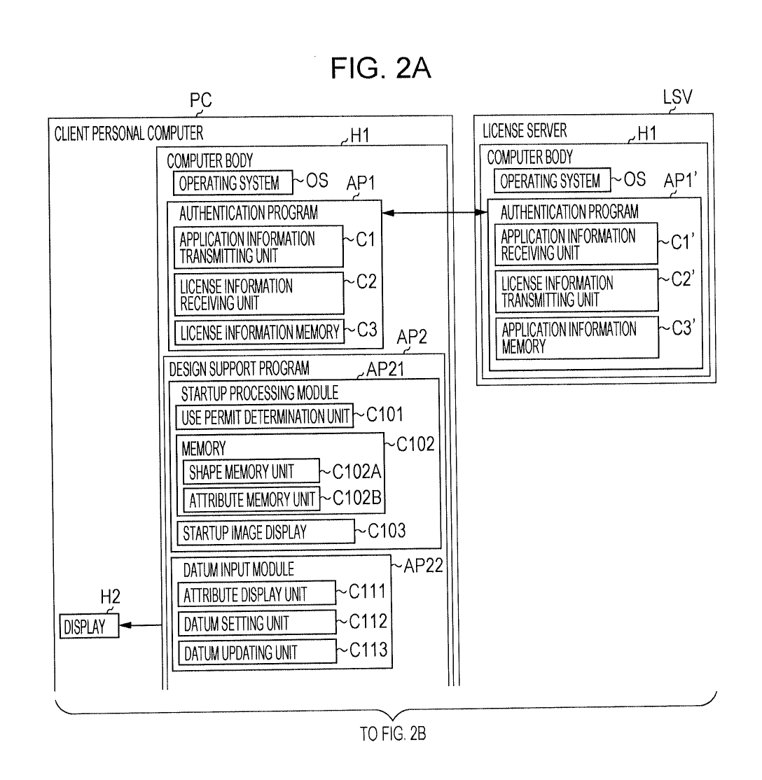

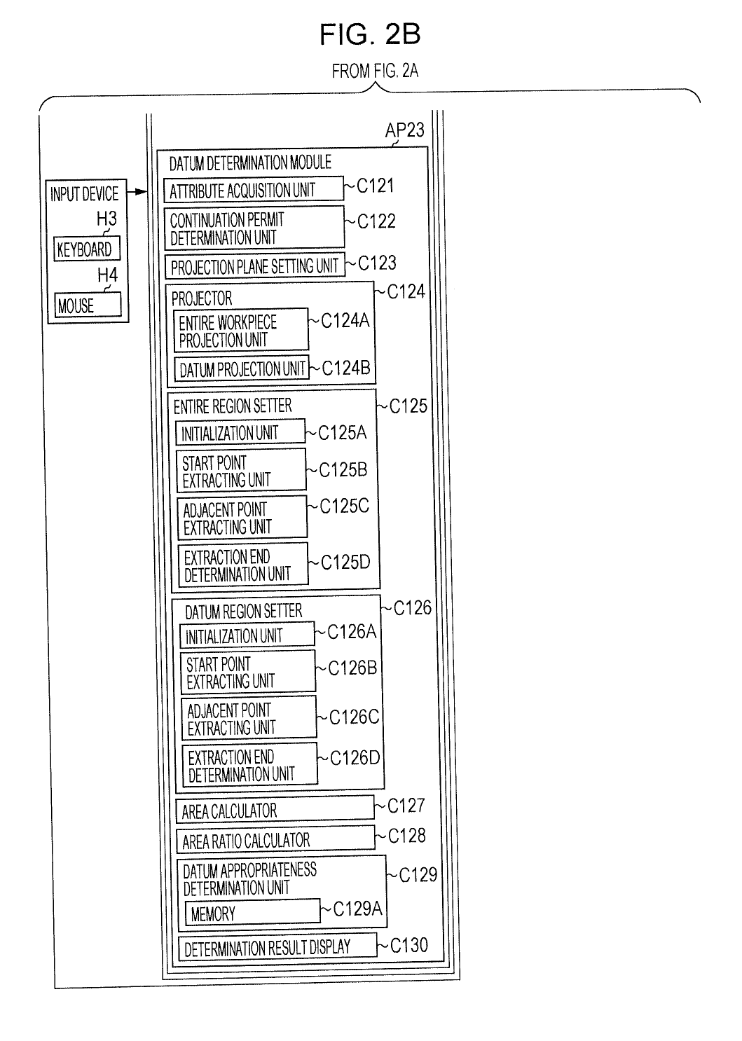

FIG. 2A and FIG. 2B are functional block diagrams illustrating functions of controllers in the client personal computer PC and the license server LSV of the first exemplary embodiment.

Referring to FIG. 2A and FIG. 2B, the computer body H1 of the client personal computer PC includes an input and output (I/O) interface. The input and output interface transmits and receives signals to and from the outside, and adjusts the levels of the input signals and the output signals. The computer body H1 includes a read-only memory (ROM). The ROM stores a program to perform a process and data for the process.

The computer body H1 also includes a random-access memory (RAM). The RAM temporarily stores data. The computer body H1 further includes a central processing unit (CPU). The CPU performs a process responsive to the program stored on the hard disk. The computer body H1 also includes a clock generator.

The client personal computer PC implements a variety of functions by executing the program stored on the hard disk, the ROM, or the like.

The hard disk in the client personal computer PC stores an operating system OS. The operating system OS controls the basic operations of the computer.

The hard disk in the client personal computer PC also stores an authentication program AP1 for design support. The authentication program AP1 for design support acquires information as to a license to use the design support system S from the license server LSV.

The hard disk in the client personal computer PC stores a design support program AP2 serving as an example of a determination program of measurement standard. The design support program AP2 includes a startup processing module AP21, a datum input module AP22, and a datum determination module AP23. The startup processing module AP21 performs a setting process to start the datum input module AP22 and the datum determination module AP23. The datum input module AP22 performs an input process of datum. The datum determination module AP23 performs a determination process of the datum.

The hard disk in the client personal computer PC also stores application programs including word processing software for document creation, and electronic mail transmitting and receiving software.

The function (controller) of each of the programs AP1 and AP2, excluding the operating system OS and application programs of related art, is described below.

The authentication program AP1 includes an application information transmitting unit C1, a license information receiving unit C2, and a license information memory C3.

The application information transmitting unit C1 transmits application information to apply for the use of the design support system S.

The license information receiving unit C2 receives license information that indicates a license to use the design support system S.

The license information memory C3 stores the license information.

The client personal computer PC of the first exemplary embodiment receives a license to use the design support system S by transmitting the application information to the license server LSV and receiving the license information from the license server LSV.

A use permit determination unit C101 determines whether to use the design support system S, based the license information in the license information memory C3.

If the determination indicates that the client personal computer PC is not permitted to use the design support system S, the use permit determination unit C101 displays on the display H2 an image indicating non-permission. The use permit determination unit C101 then ends the design support program A22.

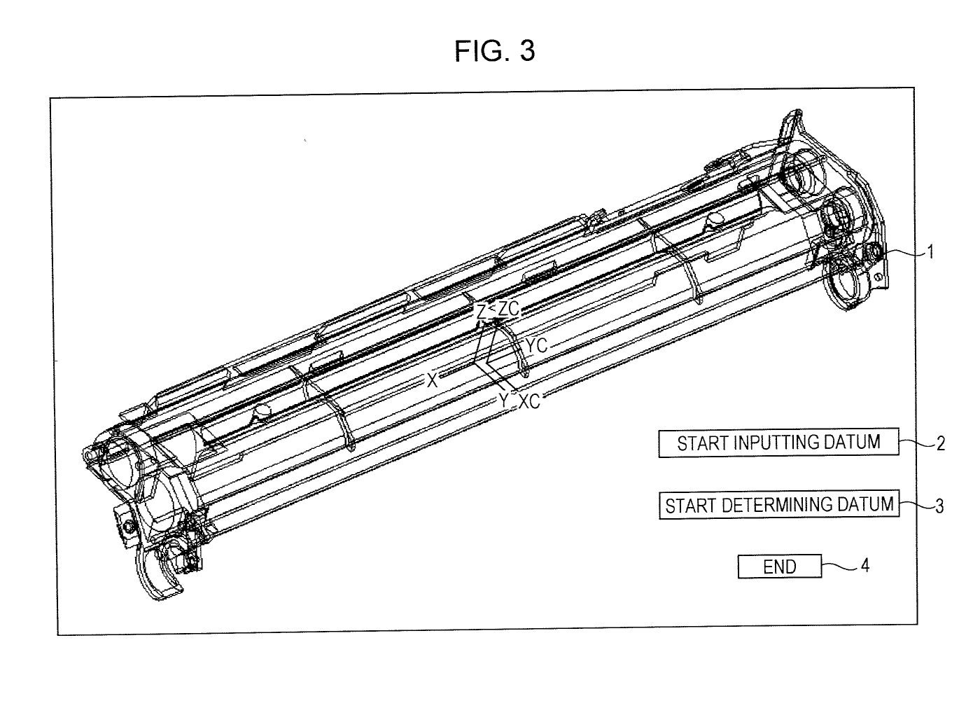

FIG. 3 is an image of a workpiece displayed on a display of the first exemplary embodiment.

In the drawings described below, the shape of the workpiece may not necessarily remain identical but may be different depending on the explanation of each figure.

A memory C102 includes a shape memory unit C102A and an attribute memory unit C102B.

The shape memory unit C102A stores information concerning a three-dimensional shape of the workpiece. Note that the shape memory unit C102A stores three-dimensional data of surface information as an example of three-dimensional shape information of the workpiece. More specifically, the shape memory unit C102A of the first exemplary embodiment stores, as the surface information, information concerning surface areas B1 through Bn of surfaces A1 through An forming the workpiece, and the shapes and locations of the surfaces A1 through An. The shape memory unit C102A of the first exemplary embodiment also stores information related to the inside of the workpiece surrounded by the surfaces A1 through An, namely, information identifying the inside of the workpiece.

The attribute memory unit C102B stores the attribute of each of the surfaces A1 through An forming the workpiece. For example, the attribute memory unit C102B of the first exemplary embodiment stores each of the surfaces A1 through An that is a fillet surface F serving as an example of a connecting surface or an end surface serving as an example of a thickness surface. The attribute memory unit 0102B of the first exemplary embodiment also stores, as an example of the attributes of surfaces, datums, and a priority order corresponding to the order according to which the datums are supported. In the first exemplary embodiment, the datum is set in a surface forming the workpiece, and is set by the unit of surface or part of the surface. Note that the setting of display colors predetermined for the fillet surface F, the end surface E, and the datum is also stored.

A startup image display C103 of the first exemplary embodiment displays an image of a workpiece 1 on the display H2 in accordance with the three-dimensional data of the workpiece 1. The startup image display C103 also displays on the display H2 the button of an image 2 to start the execution of an input process of the datum. The startup image display C103 further displays on the display H2 the button of an image 3 to start the execution of a determination process of the datum. The startup image display C103 further displays on the display H2 the button of an image 4 to end a design support process. FIG. 3 illustrates an image of a development container of a developing device in an image forming apparatus as an example of the workpiece 1 in accordance with the first exemplary embodiment. If the button of the image 2 or 3 is selected by the keyboard H3 or the mouse H4, the process responsive to the module AP22 or AP23 is performed on the selected image. If the button of an image 4 is selected by the keyboard H3 or the mouse H4, the process of the design support program AP2 is terminated.

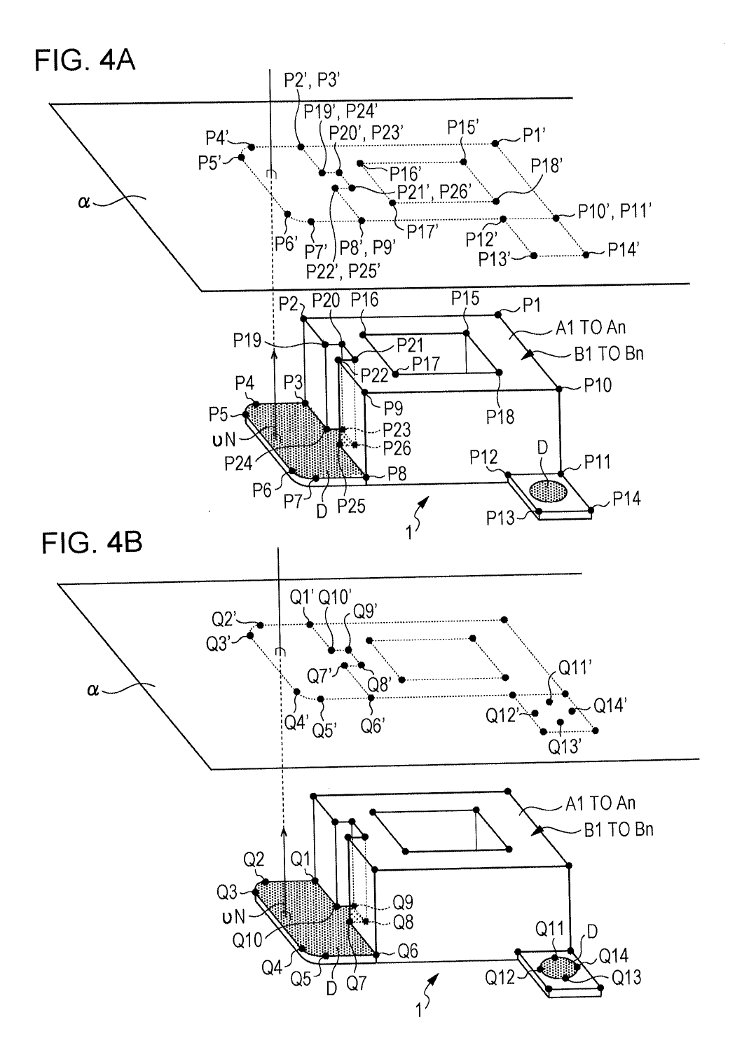

FIG. 4A and FIG. 4B illustrate the shape and projection plane of a workpiece serving as a setting target of the datum of the first exemplary embodiment. More specifically, FIG. 4A illustrates the projection plane on which the image of the entire workpiece is projected, and FIG. 4B illustrates the projection plane on which the datums are projected.

When the input process of the datum starts, an attribute display unit C111 displays on the display H2 plane settings F and E in different colors with respect to the surfaces A1 through An of the workpiece in accordance with information stored in the memory C102. The datums D, if set, are also displayed in different colors.

A datum setting unit C112 sets the datum D as an example of the measurement standard in response to an input to the keyboard H3 or the mouse H4. The datum D is set at a location where the workpiece is supported when a length of the workpiece manufactured is measured for component inspection or other purposes. The datum D is also set in the surfaces A1 through An forming the workpiece 1. Referring to FIG. 4, surfaces A1 through An as an entire single surface may be set as the datum D, in other words, the datum D may be set by the unit of surface. Instead of the unit of surface, part of the surfaces A1 to An may be set as the datum D. If part of the surface is set in the first exemplary embodiment, a circle defined by the center and radius of the circle may be set as the datum D, for example. Furthermore in the first exemplary embodiment, plural datums may be set, and the priority order of the datums may also be set. The datum D may be set using the mouse H4 to select the surfaces A1 through An or using the keyboard H3 to specify the surfaces A1 through An and the locations thereof. Since the input method of surface and region disclosed in the related art is employed as an input method in the exemplary embodiment, the detailed discussion thereof is omitted herein.

A datum updating unit C113 updates information stored in the attribute memory unit C102B when the datum D is input.

When the determination process of the datum starts, an attribute acquisition unit C121 acquires attribute information set in the surfaces A1 through An of the workpiece 1, namely, the plane settings F and E, and the setting of the datum D in accordance with the information stored in the memory C102.

A continuation permit determination unit C122 determines whether to continue the determination process of the datum D. If the datum D is not set in the first exemplary embodiment, the determination process of the datum D ends.

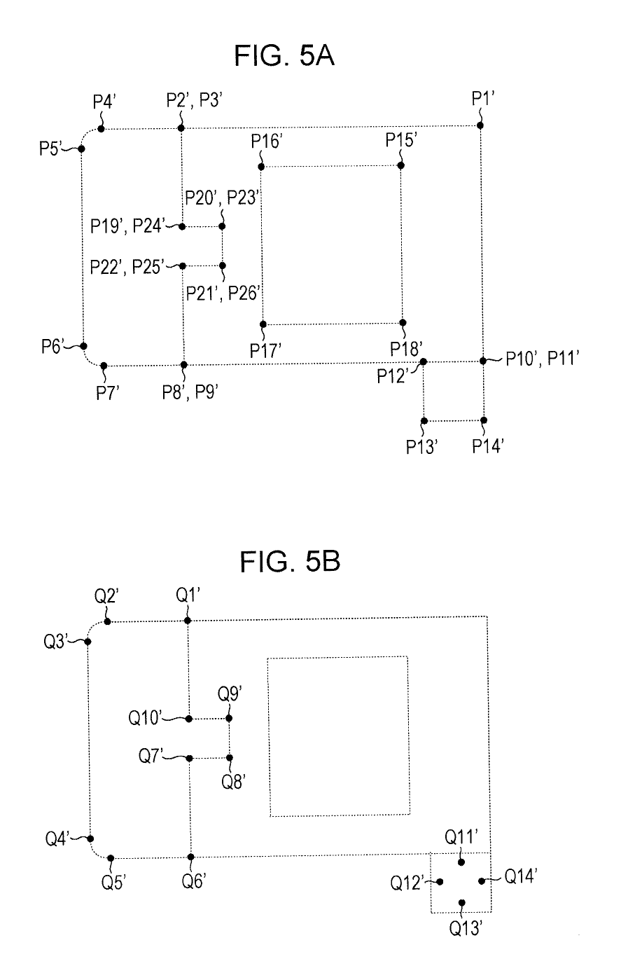

FIG. 5A and FIG. 5B illustrate a projection image of the first exemplary embodiment of the present invention. More specifically, FIG. 5A illustrates the entire projection image, and FIG. 5B illustrates the projection image of the datum.

When the datum D is set, a projection plane setting unit C123 sets a projection plane α in which the image of the workpiece 1 is projected. Referring to FIG. 4A, FIG. 4B, FIG. 5A, and FIG. 5B, a plane perpendicular to a normal vector υN normal to the surface where the datum D is set is set to be the projection plane α. The projection plane α of the first exemplary embodiment is set outside the workpiece 1, namely, the projection plane α does not intersect the surfaces A1 through An. The projection plane setting unit C123 of the first exemplary embodiment sets the projection plane α in accordance with the datum D having the highest priority from among plural datums D if the plural datums D are set. In the specification, a symbol number starting with “υ” indicates a vector quantity.

A projector C124 includes an entire workpiece projection unit C124A and a datum projection unit C124B. The projector C124 performs a process to acquire a projection image that is obtained when the image of the workpiece 1 is projected on the projection plane α.

The entire workpiece projection unit C124A, serving as an example of a calculating unit of the projection image of the entire workpiece, projects points on each of the surfaces A1 through An onto the projection plane α. Referring to FIG. 4A, the entire workpiece projection unit C124A of the first exemplary embodiment calculates, as an example of the projection image of the workpiece 1, locations P′(P1′ through Pk′) on the projection plane α to which end points P (P1 through Pk) of a boundary line forming the surfaces A1 through An are projected.

The datum projection unit C124B serving as an example of a calculating unit that calculates the projection image of a measurement standard projects each of the points on the surfaces A1 through An having the datum D onto the projection plane α. If the datum D is set in the surfaces A1 through An as illustrated in FIG. 4B, the datum projection unit C124B of the first exemplary embodiment calculates, as an example of a projection image of a surface having the measurement standard, locations Q′ (Q1′ through QL′) on the projection plane α to which end points Q (Q1 through QL) of the boundary line forming the surface having the datum D are projected. If the datum D is set as a circle, the datum projection unit C124B of the first exemplary embodiment calculates, as an example of the projection image of the surface having the measurement standard, a location on the projection plane α to which the external periphery of the circle forming the datum D is projected. In the first exemplary embodiment, for example, the datum projection unit C124B calculates, on a per datum basis, locations Q′ (Q11′ through Q14′) on the projection plane α to which quarter points Q (Q11 through Q14) predetermined along the outer periphery of the circle forming the datum D are projected.

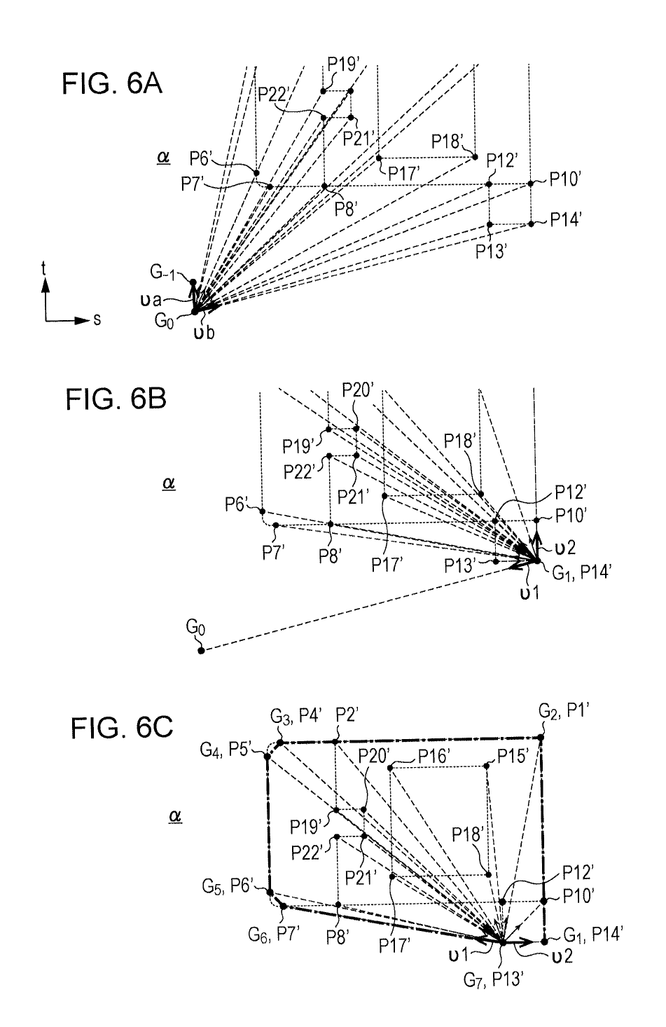

FIG. 6A through FIG. 6C illustrate an extraction process of outer periphery points in accordance with the first exemplary embodiment of the present invention. More specifically, FIG. 6A illustrates the extraction process to extract a start point, FIG. 6B illustrates the extraction process to extract an outer periphery point subsequent to the extracted start point, and FIG. 6C illustrates the extraction process to extract an outer periphery point subsequent to the extracted outer periphery point.

An entire projection setter C125 includes an initialization unit C125A, a start point extracting unit C125B, an adjacent point extracting unit C125C, and an extraction end determination unit C125D. The entire projection setter C125 sets an entire region R1 as an example of a first region in accordance with the external shape of projection images P1′ through Pk′ of the entire workpiece 1 in response to the locations P1′ through Pk′. The entire projection setter C125 of the first exemplary embodiment sets the entire region R1 in accordance with a convex polygon including the locations P1′ through Pk′. The entire projection setter C125 of the first exemplary embodiment sets the entire region R1 by extracting outer periphery points G1 through Gm placed along the outer periphery of the entire region R1 from the locations P1′ through Pk′.

In the following discussion, a location in the projection plane α of the first exemplary embodiment is described using st coordinates (s, t) of an s axis and a t axis mutually perpendicular to each other.

The initialization unit C125A performs an initial setting to extract outer periphery points G (G₁ through Gₘ). Referring to FIG. 6A, the initialization unit C125A of the first exemplary embodiment sets a start point location G₀ and an end point location G₋₁ that are predetermined so that these point locations do not overlap the projection image of the entire workpiece 1. More specifically, in the first exemplary embodiment, the initialization unit C125A sets minimum calculable coordinate values (sₘᵢₙ, tₘᵢₙ) as an example of unused coordinate values to be the start point location G₀ in the st coordinates on the projection plane α. The initialization unit C125A also sets a point shifted by a distance of +1 along the t axis from the start point location G₀ as an example of second unused coordinate values to be the end point location G₋₁ (sₘᵢₙ,tₘᵢₙ).

The start point extracting unit C1253 extracts a start point G₁ as an outer periphery point of the entire region R1. In the first exemplary embodiment, as illustrated in FIG. 6A, the start point extracting unit C125B calculates a reference vector υa extending from the start point location G₀ to the end point location G₋₁. The start point extracting unit C125B further calculates a vector υb extending from the start point location G₀ to each of the locations P1′ through Pk′. In the first exemplary embodiment, each of the vectors υa and υb is a unit vector. The start point extracting unit C125B then calculates an inner product υa·υb of the reference vector υa and each vector υb. The start point extracting unit C125B extracts a location that results in a minimum inner product υa·υb from among the inner products υa·υb, namely, extracts as the start point G₁ one of the locations P1′ through Pk′ where the inner product υa·υb is closer to −1. If there are plural locations providing the minimum inner product in the first exemplary embodiment, the location farther apart from the start point location G₀ is extracted.

The adjacent point extracting unit C125C extracts an outer periphery point Gᵢ₊₁ (one of G₂ through Gₘ) adjacent to an extracted outer periphery point Gᵢ (one of G₁ through Gₘ₋₁). If the outer periphery point Gᵢ is extracted as illustrated in FIG. 6B and FIG. 6C, the adjacent point extracting unit C125C calculates a reference vector υ1 extending from the extracted outer periphery point Gᵢ to the point Gᵢ₋₁ used in the extraction of the outer periphery point Gᵢ. The adjacent point extracting unit C125C calculates a vector υ2 extending from the extracted outer periphery point Gᵢ to each of the locations P1′ through Pk′. In the first exemplary embodiment, each of the vectors υ1 and υ2 is a unit vector. The adjacent point extracting unit C125C calculates the inner product υ1·υ2 of the reference vector υ1 and each vector υ2. One of the locations P1′ through Pk′ minimizing the inner products υ1·υ2 is extracted as an adjacent outer periphery point Gᵢ₊₁. If there are plural locations providing the minimum inner product in the first exemplary embodiment, the location farther apart from the start point location Gᵢ is extracted.

The extraction end determination unit C125D serves as an example of a determining unit configured to determine region completion, and determines whether the extraction of the outer periphery points G₁ through Gₘ of the entire region R1 is complete. When the outer periphery point Gᵢ is extracted, the extraction end determination unit C125D of the first exemplary embodiment determines whether one of the locations P1′ through Pk′ extracted as the outer periphery point Gᵢ is one of the other outer periphery points G₁ through Gₘ that has been extracted. If the one of the locations P1′ through Pk′ is extracted, the extraction end determination unit C125D determines that all the outer periphery points G₁ through Gₘ of the entire region R1 have been extracted. More specifically, as illustrated in FIG. 6C, the entire region R1 enabled to include all the locations P1′ through Pk′ is set by connecting the outer periphery points G₁ through Gₘ with a dot-dash line.

A datum region setter C126 includes an initialization unit C126A, a start point extracting unit 126B, an adjacent point extracting unit 126C, and an extraction end determination unit C126D. In accordance with locations Q1′ through QL′, the datum region setter C126 sets as an example of a second region a datum region R2 that is based on only the locations Q1′ through QL′ serving as an example of a projection image of the surface having the datum D. The datum region setter C126 operates in a way similar to the way the entire projection setter C125 operates except that the datum region setter C126 sets the datum region R2 that is responsive to a convex polygon including the locations Q1′ through QL′ in place of the locations P1′ through Pk′.

An area calculator C127 calculates an area S1 of the entire region R1 and an area S2 of the datum region R2 in the projection plane α. When all the outer periphery points G₁ through Gₘ of the entire region R1 are extracted in the first exemplary embodiment, the area calculator C127 calculates the area S1 of the entire region R1. When all the outer periphery points G₁′ through Gₘ′ of the datum region R2 are extracted, the area calculator C127 calculates the area S2 of the datum region R2.

An area ratio calculator C128 calculates an area ratio C2/S1 as an example of a magnitude of the area S2 of the datum region R2 to the area S1 of the entire region R1.

A datum appropriateness determination unit C129 includes a memory C129A that stores a predetermined threshold value. The datum appropriateness determination unit C129 determines whether the area ratio S2/S1 is higher than 60% that serves as an example of a predetermined threshold value. If the area ratio S2/S1 is higher than 60%, the datum appropriateness determination unit C129 determines that the datum D is appropriate. If the area ratio S2/S1 is equal to or lower than 60%, the datum appropriateness determination unit C129 determines that the datum D is inappropriate.

A determination result display C130 serves as an example of a notifying unit and displays on the display H2 a message image serving as an example of a notification image, and the image of the workpiece 1 and the datum D. If the datum D is determined to be appropriate, the determination result display C130 displays on the display H2 the message image indicating that the datum D is appropriate, and the image of the workpiece 1 and the datum D. If the datum D is determined to be inappropriate, the determination result display C130 displays on the display H2 a message image indicating that the datum D is inappropriate, and the image of the workpiece 1 and the datum D. If the continuation permit determination unit C122 determines that the datum D has not been set, the determination result display C130 displays on the display H2 a message image indicating that the datum D has not been set.

Referring to FIG. 2, like the computer body H1 of the client personal computer PC, the computer body H1 of the license server LSV includes an input and output interface, a ROM, a RAM, a CPU, a clock generator and the like. The license server LSV implements a variety of functions by executing programs stored on a hard disk or the ROM. The hard disk of the license server LSV stores an operating system OS. The hard disk of the license server LSV stores application programs including an authentication program AP1′ for design support. The authentication program AP1′ for design support transmits license information of the design support system S to the client personal computer PC.

The functions of the authentication program AP1′ are described below.

The authentication program AP1′ includes an application information receiving unit C1′, a license information transmitting unit C2′, and an application information memory C3′.

The application information receiving unit C1′ receives the application information from the client personal computer PC.

The license information transmitting unit C2′ transmits the license information.

The application information memory C3′ stores the application information.

The license server LSV of the first exemplary embodiment transmits and receives information to and from the client personal computer PC, and licenses the client personal computer PC to use the design support system S by transmitting the license information in response to the application information.

The process flow of the design support program AP2 of the client personal computer PC of the first exemplary embodiment is described with reference to flowcharts. The processes of the authentication programs AP1 and AP1′ of the client personal computer PC and the license server LSV are not described with reference to flowcharts since the client personal computer PC simply receives and stores the license information by transmitting the application information while the license server LSV simply receives and stores the application information and transmits the license information.

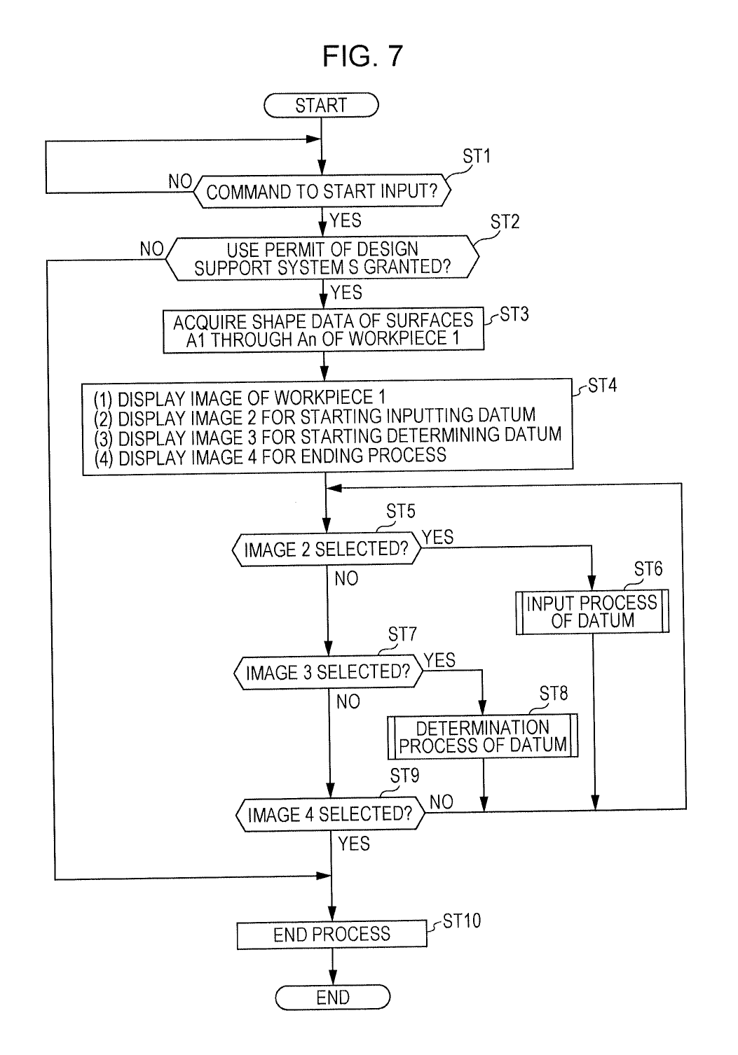

FIG. 7 is a flowchart illustrating a process of the design support program AP2 of the first exemplary embodiment of the present invention.

Operation in each ST (step) of the flowchart of FIG. 7 is performed in accordance with a program stored on the ROM or the like in the controller. Operations may be performed in parallel with another operation in a variety of processes in a multi-task fashion.

The process in the flowchart of FIG. 7 starts up when the design support program AP2 starts after the client personal computer PC is switched on.

In ST1 of FIG. 7, the controller determines whether a user has input a command to start, using the keyboard H3 or the mouse H4. If the determination result is yes in ST1, processing proceeds to ST2. If the determination result is no in ST1, the determination operation is repeated in ST1.

In ST2, the controller determines whether to permit the client personal computer PC to use the design support system S. If the determination result is yes in ST2, processing proceeds to ST3. If the determination result is no in ST2, processing proceeds to ST10.

In ST3, the controller acquires shape data of the surfaces A1 through An from the information stored on the memory C102. Processing proceeds to ST4.

The controller proceeds to ST5 after performing operations (1) through (4).

(1) Displaying image 1 of the workpiece.

(2) Displaying image 2 to start inputting the datum D.

(3) Displaying image 3 to start determining the datum D.

(4) Displaying image 4 to end the process.

In ST5, the controller determines whether the image 2 has been selected. If the determination result in ST5 is yes, processing proceeds to ST6. If the determination result in ST5 is no, processing proceeds to ST7.

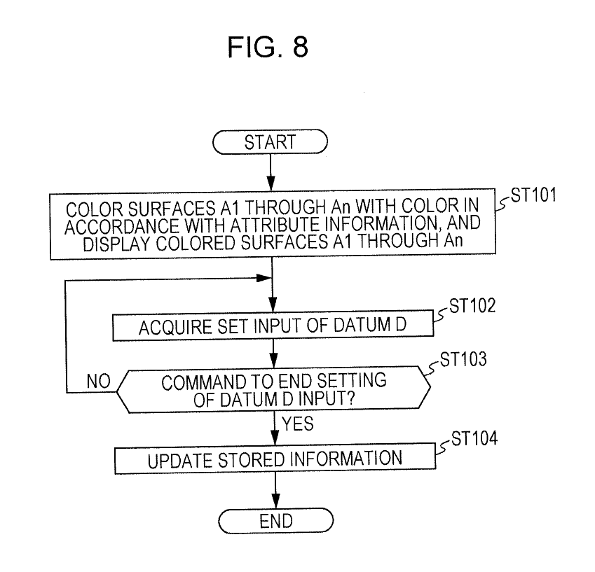

In ST6, the control performs the input process to input the datum D in a flowchart illustrated in FIG. 8 as described below. Processing then returns to ST5.

In ST7, the controller determines whether the image 3 has been selected. If the determination result in ST7 is yes, processing proceeds to ST8. If the determination result in ST7 is no, processing proceeds to ST9.

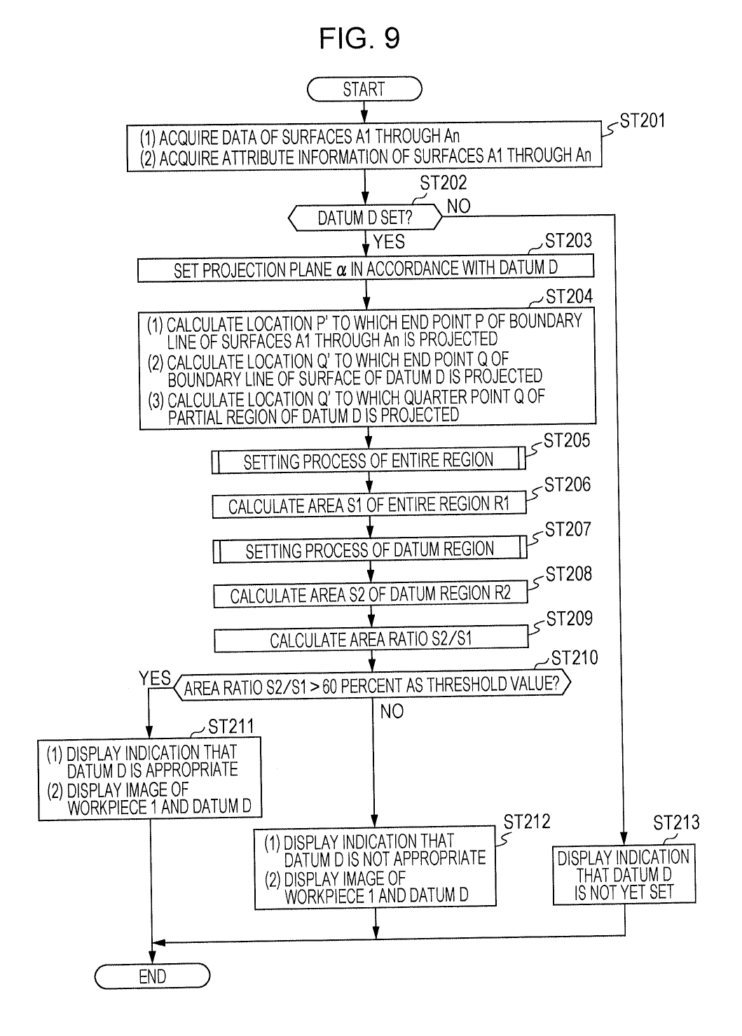

In ST8, the controller performs the determination process of the datum represented by a flowchart illustrated in FIG. 9 as described below. Processing then returns to STS.

In ST9, the controller determines whether the image 4 has been selected. If the determination result in ST9 is yes, processing proceeds to ST10. If the determination result in ST9 is no, processing returns to step ST5.

In ST10, the controller ends the process thereof.

FIG. 8 is a flowchart illustrating the subroutine in ST6 of FIG. 7 as the input process of the datum in accordance with the first exemplary embodiment of the present invention.

In ST101 of FIG. 8, the controller colors the surfaces A1 through An in accordance with attribute information and then displays the colored surfaces A1 through An. Processing then proceeds to ST102.

In ST102, the controller acquires the input datum D. Processing proceeds to ST103.

In ST103, the controller determines whether there is an input indicating the end of the setting of the datum D. If the determination result in ST103 is yes, processing proceeds to ST104. If the determination result in ST103 is no, processing returns to ST102.

In ST104, the controller updates the stored information. More specifically, the controller updates the setting of the datum D. The controller then returns to the original routine.

FIG. 9 is a flowchart illustrating the subroutine in ST8 of FIG. 7 as the determination process of the datum in accordance with the first exemplary embodiment of the present invention.

In ST201 of FIG. 9, the controller proceeds to ST202 after performing the following operations (1) and (2).

(1) Acquiring data of the surfaces A1 through An.

(2) Acquiring the attribute information of the surfaces A1 through An.

In ST202, the controller determines whether the datum D has been set. If the determination result in ST202 is yes, processing proceeds to ST203. If the determination result in ST202 is no, processing proceeds to ST213.

In ST203, the controller sets the projection plane α in accordance with the datum D. Processing proceeds to ST204.

In ST204, the controller proceeds to ST205 after performing the following operations (1) through (3).

(1) Calculating location P′ in the projection plane α to which an end point P of the boundary line of the surfaces A1 through An is projected.

(2) Calculating location Q′ in the projection plane α to which an end point Q of the boundary line on the plane of the datum D is projected.

(3) Calculating location Q′ in the projection plane α to which a quarter point Q of a partial region of the datum D is projected.

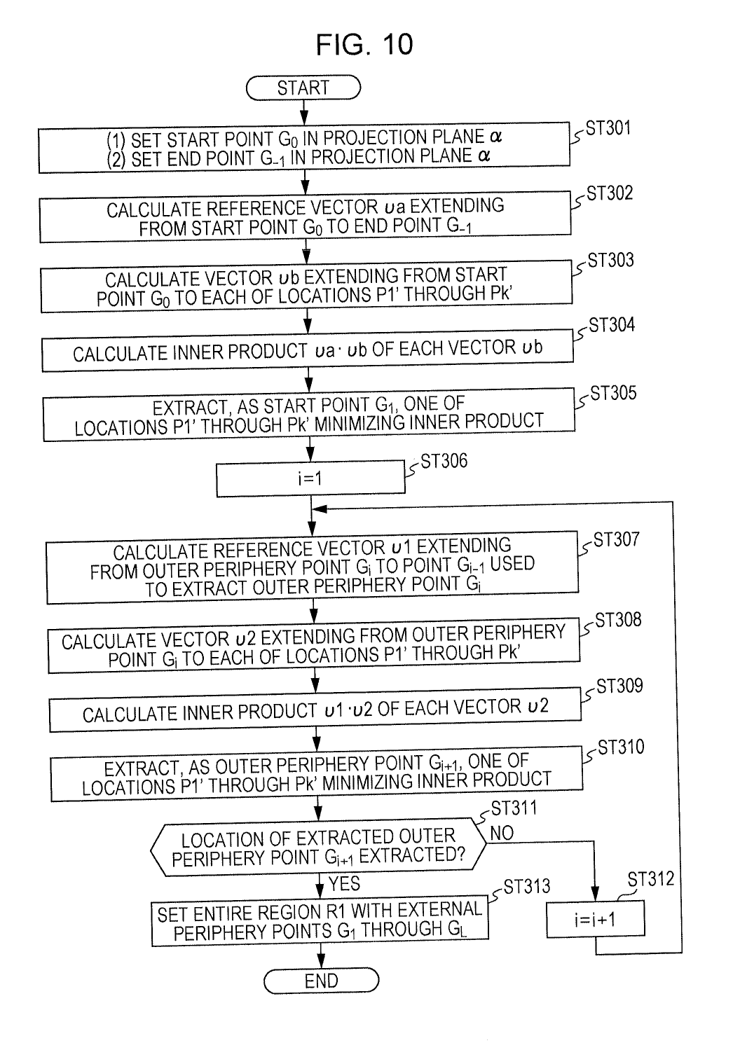

In ST205, the controller performs the subroutine as the setting process of the entire region illustrated in FIG. 10. Processing then proceeds to ST206.

The controller proceeds to ST207 after calculating the area S1 of the entire region R1 in ST206.

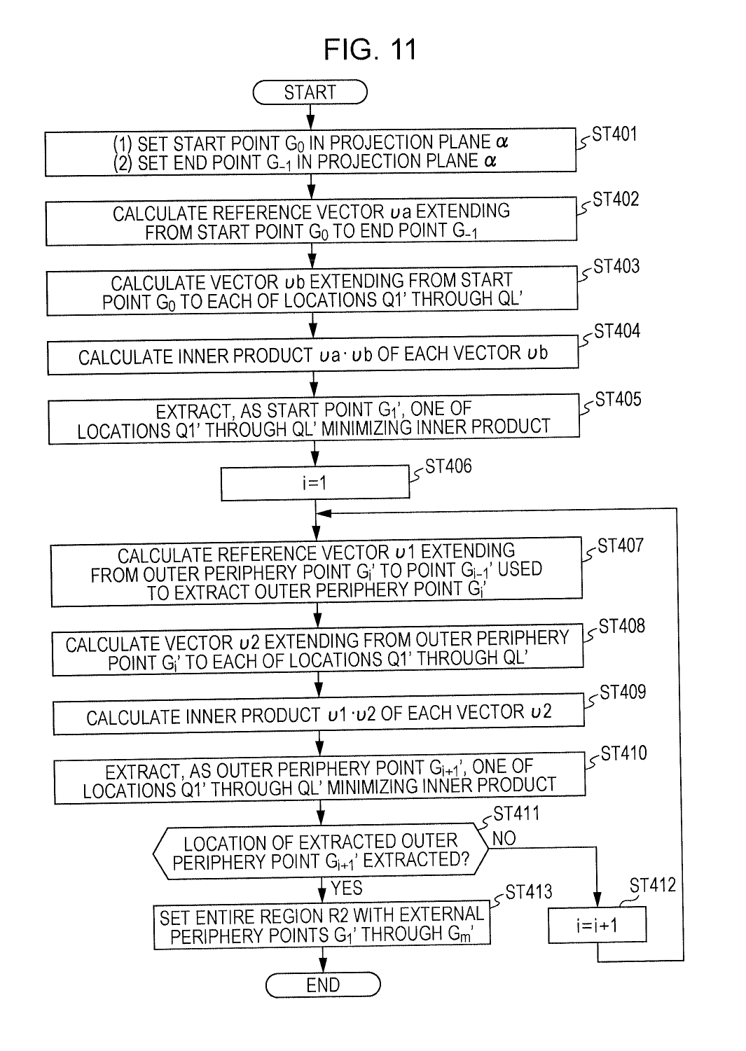

In ST207, the controller performs the subroutine as the setting process of a datum region illustrated in FIG. 11. Processing then proceeds to ST208.

In ST208, the controller calculates the area S2 of the datum region R2. Processing then proceeds to ST209.

In ST209, the controller calculates the area ratio S2/S1 of the area of the datum region R2 to the area of the entire region R1. Processing then proceeds to ST210.

In ST210, the controller determines whether the area ratio S2/S1 is higher than the threshold value of 60%. If the determination result in ST210 is yes, processing proceeds to ST211. If the determination result in ST210 is no, processing proceeds to ST212.

In ST211, the controller performs the following operations (1) and (2), and then returns to the original routine.

(1) Displaying indication on the display H2 that the datum D is appropriate.

(2) Displaying the image of the workpiece 1 and the datum D on the display H2.

In ST212, the controller performs the following operations (1) and (2), and then returns to the original routine.

(1) Displaying indication on the display H2 that the datum D is not appropriate.

(2) Displaying the image of the workpiece 1 and the datum D on the display H2.

In ST213, the controller displays on the display H2 an indication that the datum D has not yet been set, and then returns to the original routine.

FIG. 10 is a flowchart illustrating the subroutine in ST205 of FIG. 9 as the setting process of the entire region in accordance with the first exemplary embodiment of the present invention.

In ST301 of FIG. 10, the controller performs the following operations (1) and (2) and then proceeds to ST302.

(1) Setting the start point G₀ for the projection plane α.

(2) Setting the end point G_{—1} for the projection plane α.

In ST302, the controller calculates a reference vector ua extending from the start point location G₀ to the end point location G₋₁, and then proceeds to ST303.

In ST303, the controller calculates a vector υb extending from the start point location G₀ to each of the locations P1′ through Pk′, and then proceeds to ST304.

In ST304, the controller calculates the inner product υa·υb for each vector ub, and proceeds to ST305.

In ST305, the controller extracts as the start point G₁ one of the locations P1′ through Pk′ minimizing the inner product, and then proceeds to ST306.

In ST306, the controller sets i to be equal to 1 (i=1), and then proceeds to ST307.

In ST307, the controller calculates a reference vector υ1 extending from the extracted outer periphery point Gᵢ to the point Gᵢ₋₁ that has been used to extract the outer periphery point Gᵢ, and then proceeds to ST308.

In ST308, the controller calculates a vector υ2 extending from the extracted outer periphery point Gᵢ to each of the locations P1′ through Pk′, and then proceeds to ST309.

In ST309, the controller calculates the inner product υ1·υ2 for each vector υ2, and then proceeds to ST310.

In ST310, the controller extracts, as an outer periphery point Gᵢ₊₁, one of the locations P1′ through Pk′ minimizing the inner product, and then proceeds to ST311.

In ST311, the controller determines whether one of the locations P1′ through Pk′ extracted as the outer periphery point Gᵢ₊₁ has been extracted as a point along the outer periphery. If the determination result in ST311 is yes, the controller proceeds to ST313. If the determination result in ST311 is no, the controller proceeds to ST312.

In ST312, the controller sets i to be equal to (i+1), and then returns to ST307.

In ST313, the controller sets the entire region R1 by connecting the outer periphery points G₁ through Gₘ with line segments, and then returns to the determination process of the datum D.

FIG. 11 is a flowchart illustrating the subroutine in ST207 of FIG. 9 as the setting process of the datum region in accordance with the first exemplary embodiment of the present invention.

Since the setting process of FIG. 11 is different from the setting process of FIG. 10 in that the region is set in accordance with the locations Q1′ through QL′ instead of the locations P1′ through Pk′ in the setting process of FIG. 11, the detailed discussion thereof is omitted herein.

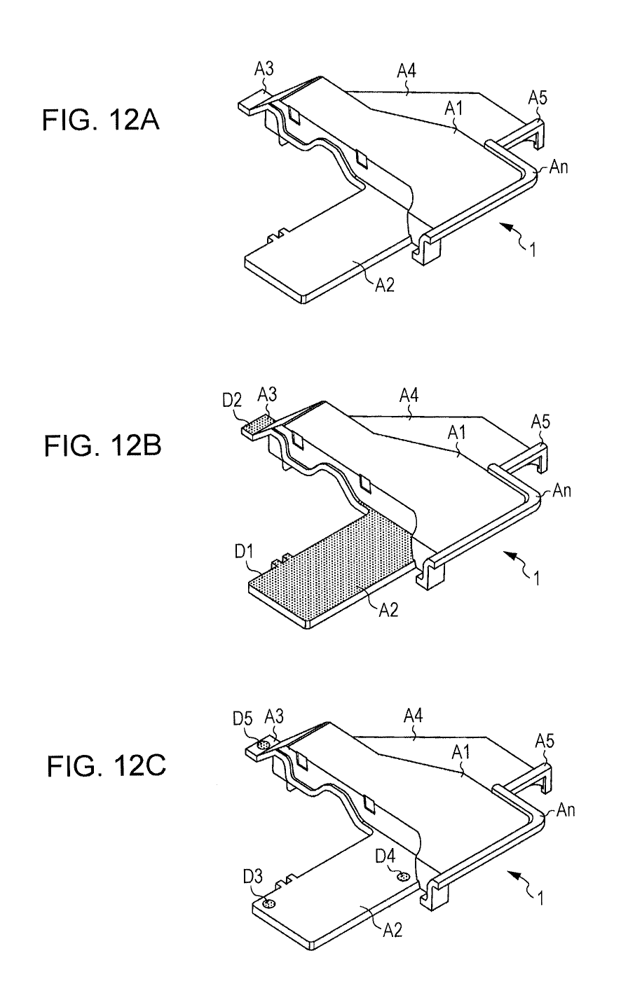

FIG. 12A through FIG. 12C illustrate the operation of the first exemplary embodiment. More specifically, FIG. 12A illustrates the three-dimensional shape of the workpiece as a setting target of the datum, FIG. 12B illustrates the example of the datum that is set by the unit of surface, and FIG. 12C illustrates an example of the datum that is set in part of the surface.

The controller performs the process of FIG. 7 in accordance with the design support program AP2 in the design support system S of the first exemplary embodiment, and displays the image of FIG. 3 on the display H2. When an input to start inputting the datum D is entered, the input process of the datum D is performed as illustrated in FIG. 8. In the input process of the datum D of the first exemplary embodiment, the setting of datums D1 and D2 on the surfaces A1 through An is input by the unit of surface as illustrated in FIG. 12B, or the setting of datums D3, D4, and D5 in partial regions of the surfaces A1 through An is input as illustrated in FIG. 12C. The input setting of the datum D is stored as attribute information in the memory C102.

When an input to start determining the datum D is entered as illustrated in FIG. 3, the determination process of FIG. 9 through FIG. 11 is performed. In the determination process of the datum D in the first exemplary embodiment, the surfaces A1 through An of the workpiece 1 and the set attribute information are acquired in accordance with the information stored in the memory C102. When the datum D has been set, the projection plane α is set in accordance with the datum D. The controller thus calculates the area S1 of the entire region R1 responsive to the outer shape of the projection image of the workpiece and the area S2 of the datum region R2 responsive to only the projection image of the surface having the datum D.

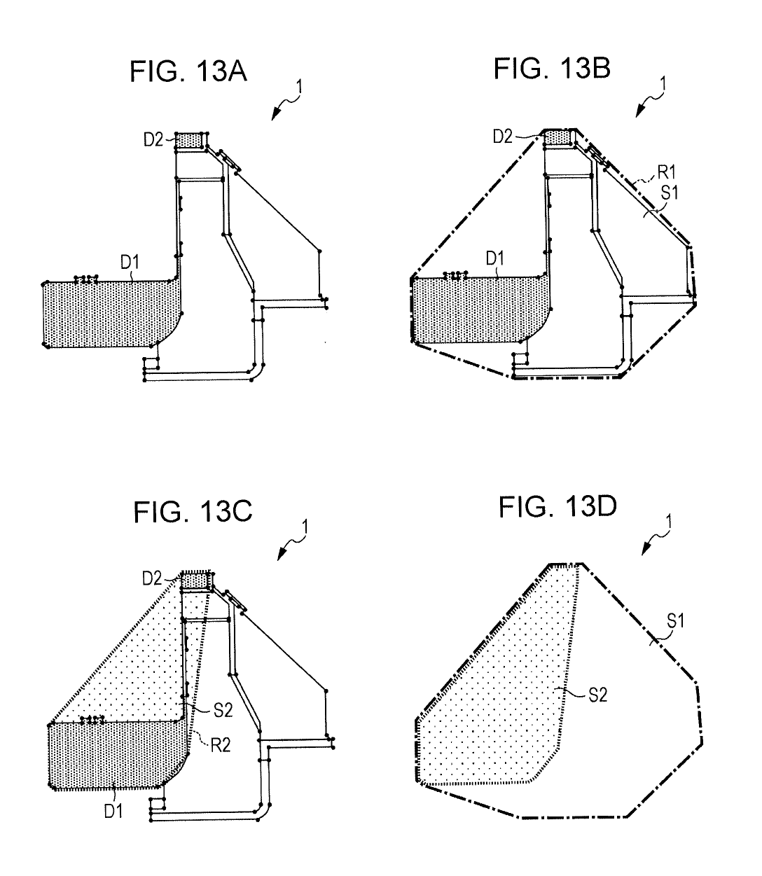

FIG. 13A through FIG. 13D illustrate the operation of the first exemplary embodiment performed on the datum of FIG. 12B. More specifically, FIG. 13A illustrates the projection plane, FIG. 13B illustrates the entire region, FIG. 13C illustrates the datum region, and FIG. 13D illustrates an area ratio of the datum region to the entire region.

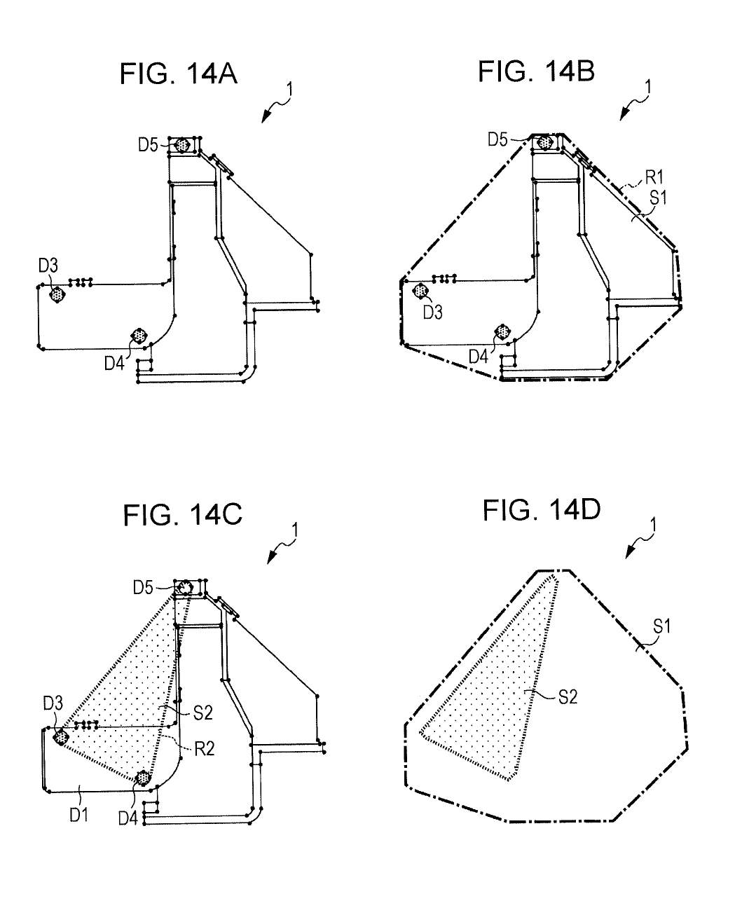

FIG. 14A through FIG. 14D illustrate the operation of the first exemplary embodiment performed on the datum of FIG. 12C. FIG. 14A illustrates the projection plane, FIG. 14B illustrates the entire region, FIG. 14C illustrates the datum region, and FIG. 14D illustrates the area ratio of the datum region to the entire region.

Referring to FIG. 12A through FIG. 12C, and FIG. 13A through FIG. 13D, end points P1 through Pk of the boundary lines of the surfaces A1 through An of the workpiece 1 are projected in the first exemplary embodiment. If the datum D is set by the unit of surface, end points Q1 through QL of the boundary line of the surface of the datum D are projected. If the datum D is set in partial regions of the surface as illustrated in FIG. 12A through FIG. 12C, and FIG. 14A through FIG. 14D, the points Q1 through QL predetermined in the region of the datum D are projected. More specifically, in the first exemplary embodiment, the controller calculates the locations P1′ through Pk′ in the projection plane α that are based on the entire workpiece 1, and the locations Q1′ through QL′ in the projection plane α that are based on the datum D.

Referring to FIG. 13B and FIG. 14B, the controller extracts the outer periphery points G₁ through Gₘ from the locations P′ with respect to the locations P1′ through Pk′ of the entire workpiece 1 in a manner such that the outer periphery points G₁ through Gₘ include the locations P′. The controller calculates the area S1 of the entire region R1 formed of a convex polygon having the outer periphery points G₁ through Gₘ as apexes thereof. Similarly, referring to FIG. 13C and FIG. 14C, the controller extracts the outer periphery points G₁′ through Gₘ′ from the locations Q′ with respect to the locations Q1′ through QL′ that are based on the datum D, in a manner such that the outer periphery points G₁′ through Gₘ′ include the locations Q′. The controller calculates the area S2 of the datum region R2 formed of a convex polygon having the outer periphery points G₁′ through Gₘ′ as the apexes thereof. If the area ratio S2/S1 is higher than the threshold value of 60%, the controller determines that the datum D is appropriate. If the area ratio S2/S1 is below the threshold value 60%, the controller determines that the datum D is inappropriate.

A length of a workpiece manufactured is measured, and then compared with a design length of the workpiece to check a deviation of the length of the workpiece from the design length. The datum D is set in accordance with a location of the workpiece where the workpiece is supported. More specifically, the datum D is typically set in advance by a design engineer. A measuring engineer, including a machining operator or an inspector, supports and secures the workpiece 1 with reference to the datum D, and measures the length and shape of the workpiece 1. The datum D is set for the purpose of making the measurement methods of measuring engineers uniform and stabilizing the measurement results. However, the datum D may still possibly be subject to the knowledge and experience of each design engineer, and there are cases when the datum D set by the design engineer is inappropriate.

A datum surface having a smaller area with reference to the entire workpiece 1 or plural datum surfaces having narrow spacings therebetween may be set. In such a case, the workpiece 1 tends to be supported in a localized fashion. In other words, the workpiece 1 may be supported at a location thereof off the center of gravity of the workpiece 1, and may be inclined by the effect of moment. Even if the support location is aligned with the center of gravity of the workpiece 1, localized supporting may cause the workpiece 1 to be distorted if the workpiece 1 has an elongated shape. The end portion of the workpiece 1 off the support location is not supported, leading to a distortion of the workpiece 1. In other words, an inappropriate datum may cause the measuring engineer to measure the workpiece 1 in an unstable posture or shape, possibly leading to an error in the measurement of the length and shape. In the related art that does not involve a determination as to whether the datum D is appropriate or not, a measurement operation may be performed without noticing an inappropriate datum. The measurement reliability may thus be degraded.

In accordance with the first exemplary embodiment, a determination as to whether the datum D is appropriate or not is determined in accordance with the area ratio S2/S1 of the datum region R2 to the entire region R1. If the ratio of the datum region R2 is smaller, the datum D is determined to be inappropriate. More specifically, the datum region R2 of the first exemplary embodiment depends on locations of the datums D or a region sandwiched between the datums D. During the measurement, the datum region R2 depends on the support locations or the region that is sandwiched between and both-end supported by the support locations. In this case, the datum region R2 is a region that is easier to stabilize in posture, but a larger measurement error may result as the magnitude of the datum region R2 to the entire region R1 increases. In the first exemplary embodiment, the determination as to whether the datum D is appropriate or not is determined by referring to the magnitude of the datum region R2 that occupies the entire region R1.

In accordance with the first exemplary embodiment, the datum D likely to cause the workpiece 1 to be unstable in posture or shape is more easily recognized during the use of the design support system S.

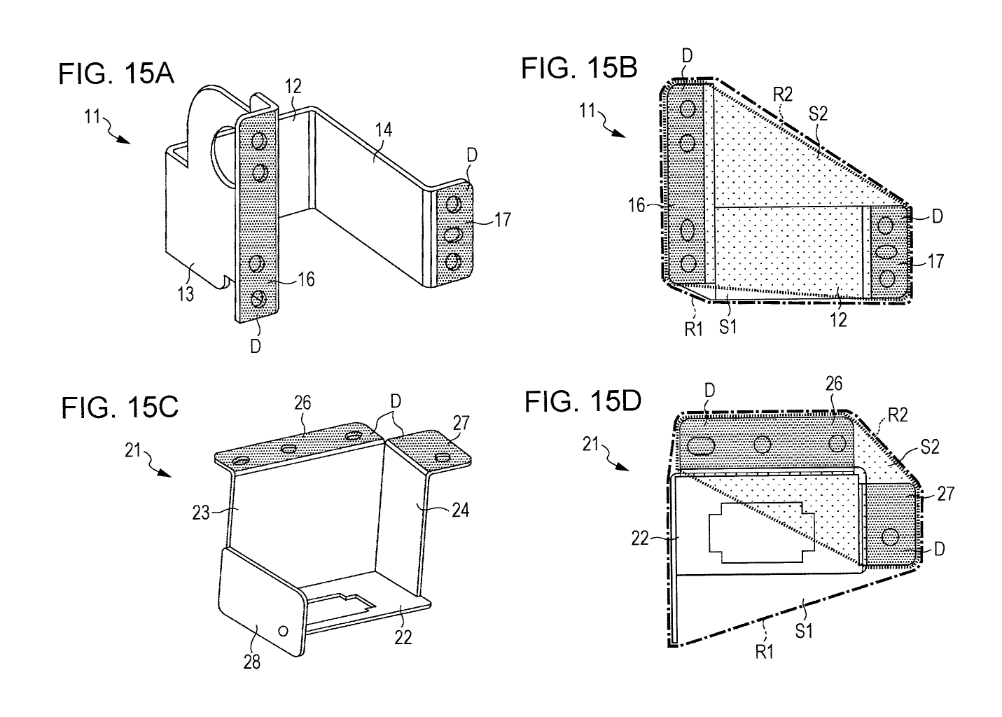

FIG. 15A through FIG. 15D illustrate the operation of the first exemplary embodiment. More specifically, FIG. 15A illustrates an example in which the datum is appropriate, FIG. 15B illustrates an area ratio in FIG. 15A, FIG. 15C illustrates an example in which the datum is not appropriate, and FIG. 15D illustrates the area ratio in FIG. 15C.

The datum D set in two types of components 11 and 21 that are in a bent shape as an example of the workpiece 1 is described below.

As illustrated in FIG. 15A, the first component 11 includes a rectangular body plate portion 12, side plate portions 13 and 14 that respectively extend from left and right edges of the body plate portion 12 in a direction perpendicular to the plane of the body plate portion 12, and flange portions 16 and 17 that extend at a right angle from the edges of the leg portions 13 and 14 in a bent configuration. As illustrated in FIG. 15C, the second component 21 includes a rectangular body plate portion 22, side plate portions 23 and 24 that extends from the adjacent edges of the rectangular body plate portion 22 in a direction perpendicular to the plane of the rectangular body plate portion 22, and flange portions 26 and 26 that extend from the edges of the side plate portions 23 and 24. The second component 21 also includes a side plate portion 28 that extends from the other edge of the rectangular body plate portion 22 opposite to the edge from which the side plate portion 24 extends. The side plate portion 28 projects forward beyond the front edge of the body plate portion 22 in FIG. 15C. In each of the first component 11 and the second component 22, the ends of the side plate portions, namely, the datum D is set in all the surfaces of the flange portions 16, 17, 26, and 27.

The first component 11 is supported at the flange portions 16 and 17 striding across the body plate portion 12. In other words, the first component 11 is supported at separate locations on outer periphery ends. The body plate portions 12, and the side plate portions 13 and 14 are less susceptible to distortion and inclination, and measurement accuracy is easy to achieve. On the other hand, the second entire component 21 is supported at the flange portions 26 and 27 which are deviated in position from the whole component 21. In the component 21, the center of gravity thereof is off the support locations and the side plate portion 28 in a projected form that is spaced apart from the support locations. The component 21 may possibly suffer from inclination and distortion. In particular, the side plate portion 28 far apart from the support locations is more likely to suffer from the effect of inclination and distortion. There is a possibility of measurement error.

In the first exemplary embodiment, the datum D of the first component 11 of FIG. 15B provides an increased ratio of the datum region R2 to the entire region R1 in comparison with the threshold value, and is thus determined to be appropriate. In contrast, the datum D of the second component 21 of FIG. 15D provides a decreased ratio of the datum region R2 to the entire region R1, and is thus determined to be inappropriate. In the first exemplary embodiment, the use of the inappropriate datum D is less likely.

Referring to FIG. 12C, and FIG. 14A through FIG. 14D, datums D3 through D5 of spots may be set in parts of surfaces in the design support system S of the first exemplary embodiment. The appropriateness of the spot datums D3 through D5 may thus be determined.

To measure a workpiece manufactured in the first exemplary embodiment, the workpiece may be supported and secured at part of the surface depending on the shape of the workpiece or the configuration of a measuring apparatus. This is intended for a measuring engineer to smoothly set the workpiece on the measuring apparatus. For example, the workpiece may have a surface that is wide enough to be distorted or deflected in the outer edge portion thereof as the distance from the support location at the part of the surface increases. A larger measurement error may result. If the surface is set as the datum D, geometric tolerance of the surface needs to be accounted for. There are cases that a dot is desirably set as the datum D. In such a case, the appropriateness of the datum D is desirably determined by specifying a spot in place of a surface for the datum D. The first exemplary embodiment is thus configured so that the datum D of a spot may be input.

If a determination is made on a surface-based datum D only in the design support system S, each of the surfaces A1 through An having the datums D3 through D5 is determined as a surface-based datum D rather than as spot-based datums D3 through D5. In this case, a datum region responsive to the surface-based datum tends to be larger than a datum region responsive to the spot-based datum. As a result, the area ratio S2/S1 is likely to be higher than the threshold value, and the datum D is likely to be determined to be appropriate. This could lead to an erroneous determination result, namely, although the spot-based datum actually supported is inappropriate, there is a possibility that the datum is determined to be appropriate.

In contrast, the design support system S of the first exemplary embodiment sets quarter points Q1 through QL on each of the spot-based datums D3 through D5, and then sets the datum region R2 in accordance with the locations Q1′ through QL′ to which the quarter points Q1 through QL are projected. The datum region R2 is thus more easily set in response to only parts of the datums D3 through D5, and the area S2 responsive to the set locations of the spot-based datums D3 through D5 is more easily calculated. The appropriateness of the spot-based datums D3 through D5 is determined at a high precision level in the first exemplary embodiment in comparison with the case in which a determination is performed on the surface-based datum only.

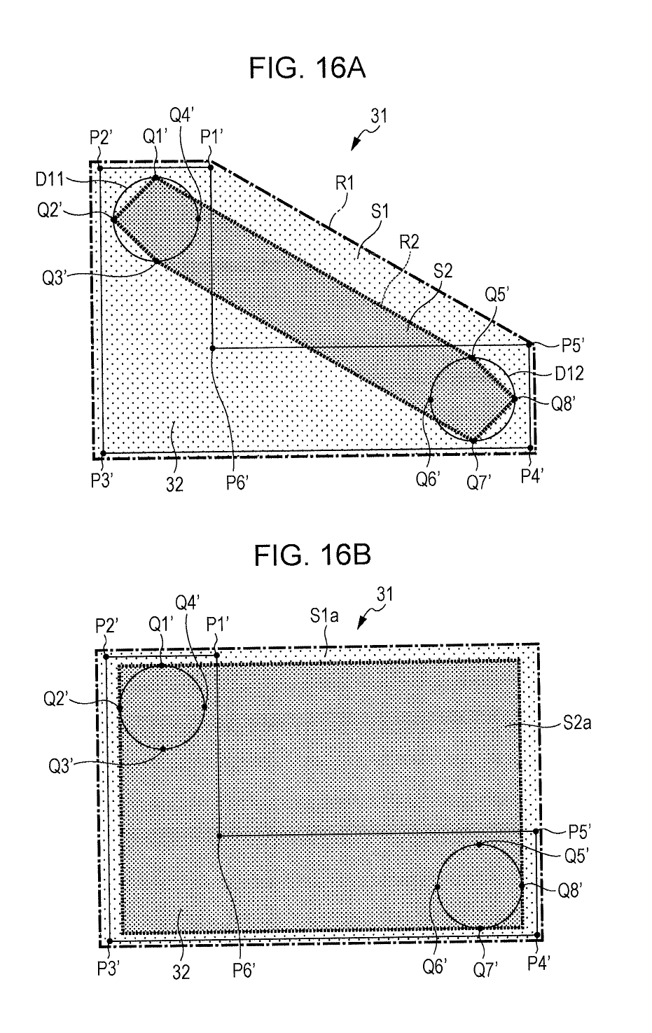

FIG. 16A and FIG. 16B illustrate the area ratio of the areas set in the method of the first exemplary embodiment and the area ratio of the areas set in another method. FIG. 16A illustrates the areas set in the method of the first exemplary embodiment, and FIG. 16B illustrates the area of an external shape with maximum dimensions.

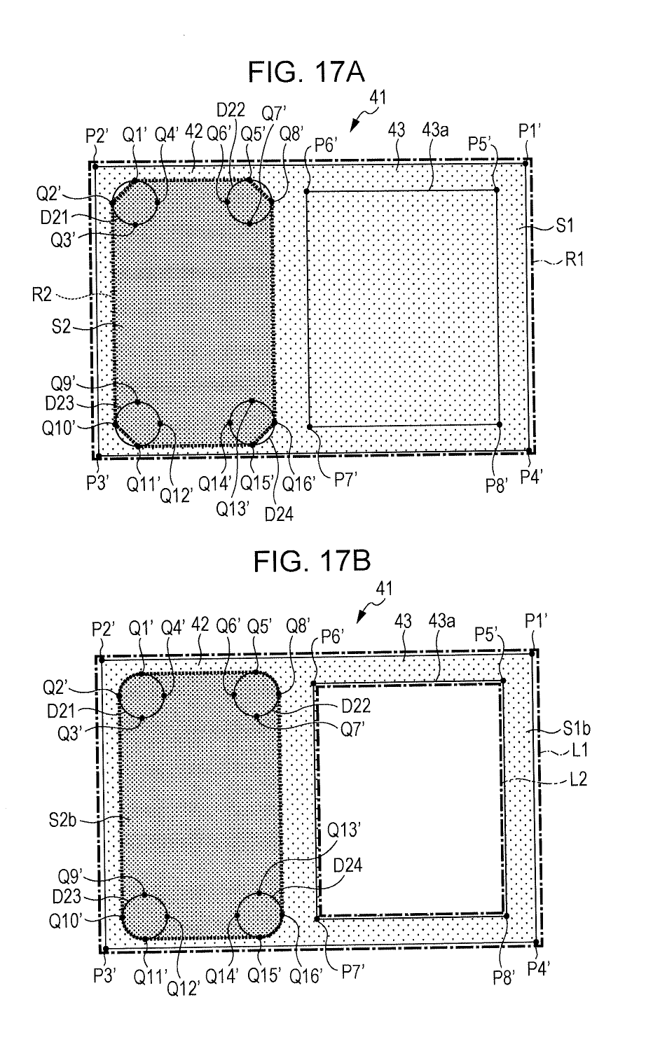

FIG. 17A and FIG. 17B illustrate the area ratio of the areas set in the method of the first exemplary embodiment and the area ratio of the areas set in another method. More specifically, FIG. 17A illustrates the areas set in the method of the first exemplary embodiment, and FIG. 17B illustrates a projection area.

In the first exemplary embodiment, the controller calculates the area ratio S2/S1 in accordance with the regions R1 and R2 that are set in a convex inclusion shape serving as an example of a shape of a convex polygon including the projection image of the workpiece 1 and the datum D. The area herein may refer to an area of a maximum dimensional external shape that is approximated by a rectangle having sides in parallel with the coordinates axes so that the projection image is included in the area as illustrated in FIG. 16B. The area herein may also refer to the projection area of the projection image itself as illustrated in FIG. 17B. However, there is a possibility that the determination results of the datum in accordance with the area of the maximum dimensional external shape or the projection area may be inappropriate.

Datums D11 and D12 may now be set at the two ends of a letter-L projection shape 31 serving as an example of a projection image. In accordance with the method of using the maximum dimensional external shape, an area S1a of the entire workpiece is an area of a rectangle enclosed by a dot-dash line and having two diagonally opposite corners at the ends of the letter-L projection shape 31. An area S2a of the datums D11 and D12 is an area of a rectangle enclosed by a broken line and having two diagonally opposite corners respectively near the two ends of a letter-L shape. The area ratio S2a/S1a is close to 1, and the datums D11 and D12 tend to be determined to be appropriate.

A corner 32 of the letter-L projection shape 31 is off a line connecting the datums D11 and D12 in the letter-L projection shape 31, and there is a possibility that a measurement error results. The datums D11 and D12 are desirably determined to be inappropriate.

The entire region R1 is a region of a pentagon enclosed by a dot-dash line in the convex inclusion shape (a circumscribing polygon) of the first exemplary embodiment as illustrated in FIG. 16A. The datum region R2 is a region that is enclosed by a broken line, made of short and thin line segments extending in a width direction, and terminated at the datums D11 and D12. The area ratio S2/S1 tends to be smaller, and the datums D11 and D12 are determined to be inappropriate. This tends to lead to a correct determination result in the first exemplary embodiment though there is a possibility of erroneous determination result with the method of using the maximum dimensional external shape.

Referring to FIG. 17B, datums D21, D22, D23, and D24 may be set at four corners of a body portion 42 on the left-hand side of a rectangular projection shape 41 serving as an example of the projection image, and a frame 43 defined by a cutout 43a may be set to the right of the body portion 42. The entire projection area is a rectangular region S1b enclosed by dot-dash lines L1 and L2. An area S2b based on the datums D21 through D24 is a rectangular area S2b enclosed by a broken line. Since the area of the frame 43 is small in comparison with the entire area S1b, the area S2b of the body portion 42 is predominant in the entire area S1b. The area ratio S2b/S1b is close to 1 in the projection area, and there are cases that the datums D21 through D24 are determined to be appropriate.

The frame 43 on the right-hand side in the projection shape 41 of FIG. 17B is spaced apart from the datums D21 through D24. During the measurement, the workpiece is cantilevered, and may be distorted in posture. For this reason, the datums D21 through D24 are desirably determined to be inappropriate.

The entire region R1 is a rectangular region enclosed by a dot-dash line in the convex inclusion shape (a circumscribing polygon) of the first exemplary embodiment as illustrated in FIG. 17A. The datum region R2 corresponds to the area of the body portion 43. The area ratio S2/S1 tends to be smaller, and the datums D21 through D24 are determined to be inappropriate. In accordance with the first exemplary embodiment, the appropriateness determination is likely to be correctly performed in accordance with the projection area even when there is a possibility of erroneous determination.

### Second Exemplary Embodiment

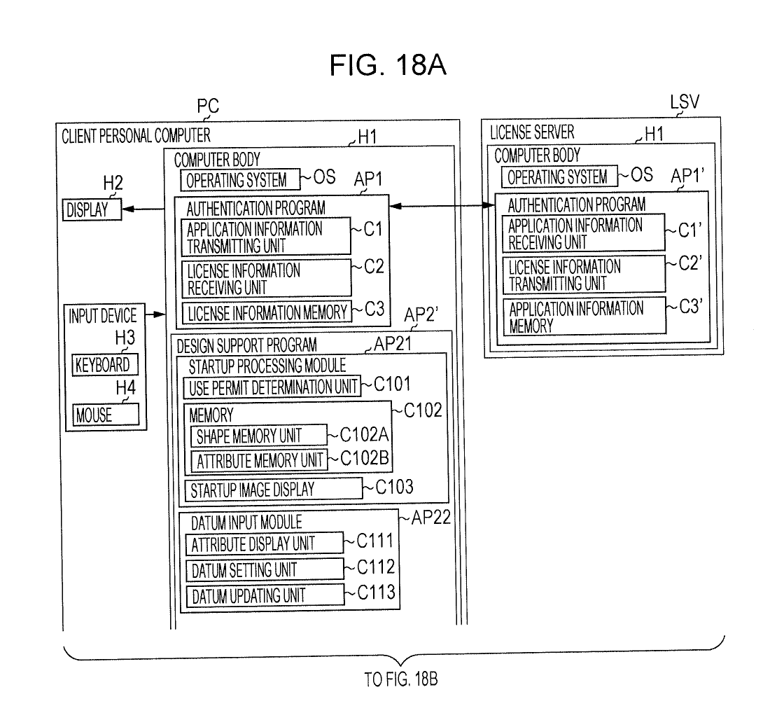

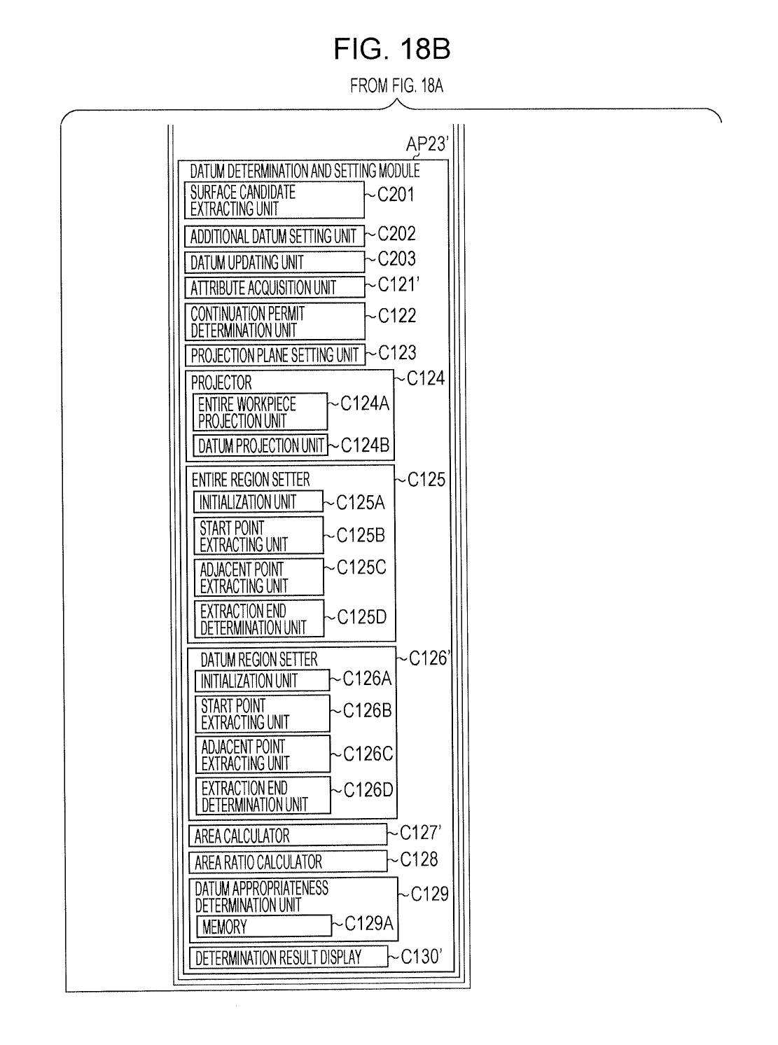

FIG. 18A and FIG. 18B correspond to FIG. 2A and FIG. 2B of the first exemplary embodiment and illustrate functional block diagrams of functions of controllers of a client personal computer and a license server of a second exemplary embodiment.

A design support system S of the second exemplary embodiment of the present invention is described below. In the discussion of the second exemplary embodiment, elements identical to those of the first exemplary embodiment are designated with the same reference numerals, and the discussion thereof is omitted. Differences between the first exemplary embodiment and the second exemplary embodiment are described below.

Referring to FIG. 18A and FIG. 18B, a design support program AP2′ of the second exemplary embodiment includes a datum determination and setting module AP23′ in place of the datum determination module AP23 of the first exemplary embodiment. The datum determination and setting module AP23′ is identical to the datum determination module AP23 of the first exemplary embodiment except for units C121′, C126′, C127′, and C130′. The datum determination and setting module AP23′ of the second exemplary embodiment further includes a surface candidate extracting unit C201 of datum, an additional datum setting unit C202, and a datum updating unit C203.

The surface candidate extracting unit C201 extracts a surface candidate of additional datum D″ as an example of a second measurement standard from the surfaces A1 through An. If the datum D is determined to be inappropriate, the surface candidate extracting unit C201 of the second exemplary embodiment extracts as a surface candidate of the additional datum D″ one of the surfaces A1 through An that has no datum D set thereon and has the same normal line direction as the datum D. If no such surface is extracted, the controller ends the process and returns to the original routine.

The additional datum setting unit C202 serves as an example of a second measurement standard setting unit. Based on the datum D, the controller sets in one of the surfaces A1 through An different from the datum D, the additional datum D″ as an example of part different from the datum D. The additional datum setting unit C202 of the second exemplary embodiment sets to be the additional datum D″ in one of the surfaces A1 through An that is farthest apart from the datum D having the highest input priority, from among extracted surface candidates A1 through An.

When the additional datum D″ is set, the datum updating unit C203 updates the information stored in the memory C102. In the second exemplary embodiment, the additional datum D″ is stored in the same way as the datum D except that attribute information indicating the datum that is added by the surface candidate extracting unit C201 and the additional datum setting unit C202 is attached to the additional datum D″. More specifically, the additional datum D″ is processed by the units C122 through C128 other than the units C121′, C126′, C127′, and C130′ in a way similar to the way the datum D is processed.

The attribute acquisition unit C121′ of the second exemplary embodiment acquires the setting of the datum D (D″) in response to the start of the input process of the datum D or in response to the setting of the additional datum D″. This operation is different from the first exemplary embodiment.

Prior to the setting of the additional datum D″, the datum region setter C126′ of the second exemplary embodiment sets to be an example of the second region the datum region R2 that is based on only the projection images Q1′ through QL′ of the surface having the datum D. Subsequent to the setting of the additional datum D″, the datum region setter C126′ of the second exemplary embodiment sets the datum region R2 that is based on the projection image of the surface having the datum D and the projection images Q1′ through QL′ of the surface having the additional datum D″. Since this is the only difference between the datum region setter C126′ and the datum region setter C126 in the first exemplary embodiment, the detailed discussion of the datum region setter C126′ is omitted.

Prior to the setting of the additional datum D″, the area calculator C127′ of the second exemplary embodiment calculates the area S2 of the datum region R2 that is based on only the projection image of the surface having the datum D. Subsequent to the setting of the additional datum D″, the area calculator C127′ of the second exemplary embodiment calculates the area of the datum region R2 that is based on the projection image of the surface having the datum D and the projection image of the surface having the additional datum D″. Since this is the only difference between the area calculator C127′ and the area calculator C127 in the first exemplary embodiment, the detailed discussion of the area calculator C127′ is omitted.

If the datum D is determined to be appropriate subsequent to the setting of the additional datum D″, the determination result display C130′ of the second exemplary embodiment displays on the display H2 a message indicating that the datum D (D″) is appropriate together with the images of the workpiece 1, the datum D, and the additional datum D″.

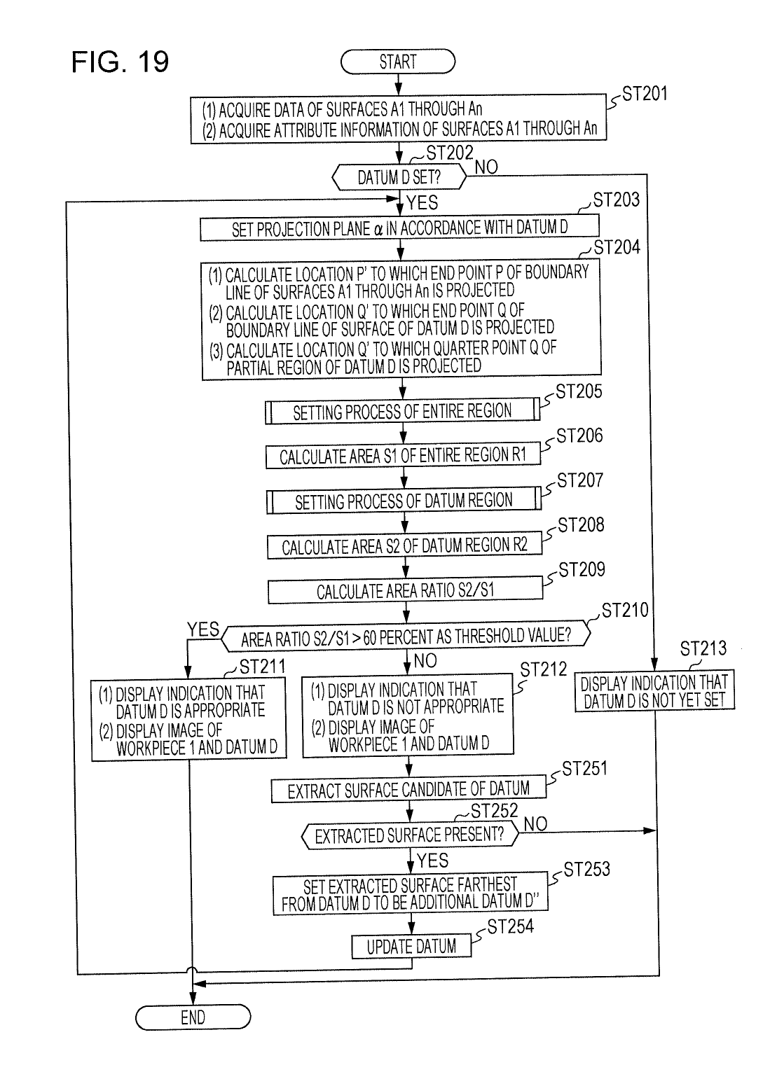

FIG. 19 is a flowchart corresponding to the flowchart of FIG. 9, and illustrating a determination and setting process of the datum in accordance with the second exemplary embodiment.

The flowchart of FIG. 19 for the determination and setting process of the datum in accordance with the second exemplary embodiment is different from the flowchart of the determination process of datum in accordance with the first exemplary embodiment in that the flowchart of FIG. 19 additionally includes ST251 through ST254. Operations in ST251 through ST254 are described below.

In ST251 of FIG. 19, the controller extracts a surface candidate for the additional datum in accordance with the normal line of the datum D, and then proceeds to ST252.

In ST252, the controller determines whether the surface candidate has been extracted. If the determination result in ST252 is yes, processing proceeds to ST253. If the determination result in ST252 is no, the controller returns to the original routine.

In ST253, the controller sets the additional datum and then proceeds to ST254.

In ST254, the controller updates the stored information. More specifically, the controller updates the setting of the additional datum, and then returns to ST203.

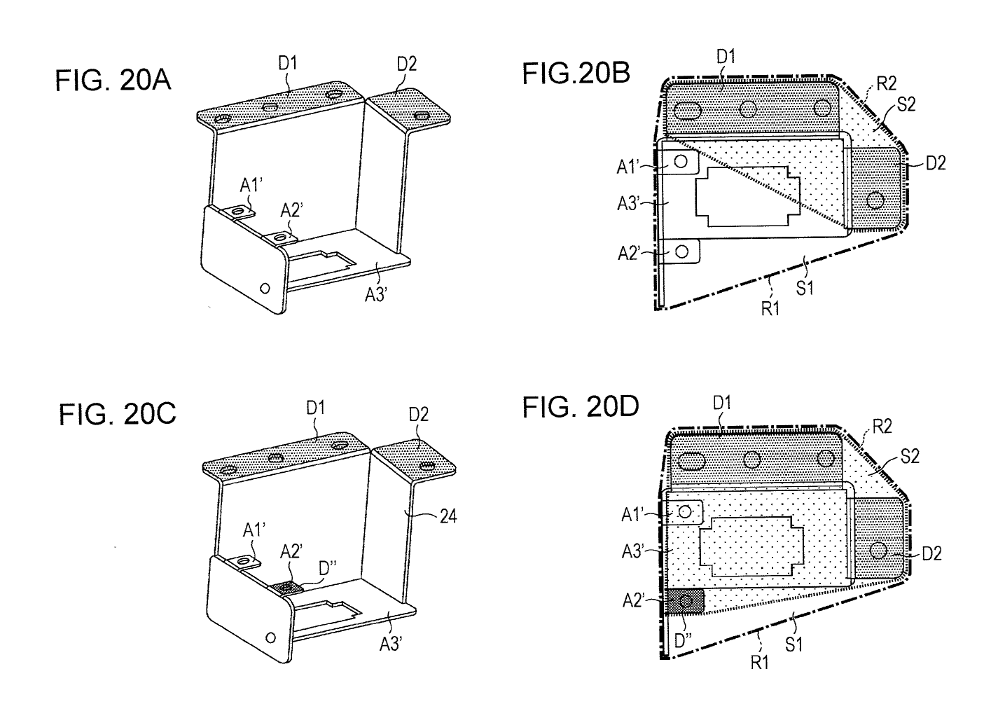

FIG. 20A through FIG. 20D illustrate the operation of the second exemplary embodiment. More specifically, FIG. 20A illustrates the input datum, FIG. 20B illustrates the area ratio in FIG. 20A, FIG. 20C illustrates the additional datum, and FIG. 20D illustrates the area ratio in FIG. 20C.

The design support system S configured in accordance with the second exemplary embodiment receives the datum D in a way similar to the way the design support system S in the first exemplary embodiment receives the datum D, and determines whether the datum D input by a design engineer or other engineers is appropriate. In the second exemplary embodiment, as in the first embodiment, an appropriate measurement standard is easy to set in comparison with the case in which the user determines whether the measurement standard is appropriate or not.

The design support system S of the second exemplary embodiment sets the additional datum D″ if the input datums D1 and D2 are determined to be inappropriate as illustrated in FIG. 20A and 20B. More specifically, surfaces A1′, A2′, and A3′ having the normal line identical the normal line of the datum D1 and having no datums D1 and D2 set thereon are extracted from the surfaces A1 through An of the workpiece 1 in accordance with the input datum D having a higher priority. The surface A2′ farther from the datum D1, from among the extracted surfaces A1′ through A3′, is set to be the additional datum D″. In other words, in the second exemplary embodiment, the surface A2′ that is likely to increase the area S2 of the datum region R2 and is difficult to be localized because of the relationship with the datum D1 is set to be the additional datum D″. As illustrated in FIG. 20C and FIG. 20D in the second exemplary embodiment, the controller calculates the area S2 of the datum region R2 and the area ratio S2/S1, based on the input datum D and additional datum D″, and determines whether the datums D and D″ are appropriate.

If the datums D and D″ are appropriate, the controller displays on the display H2 an indication that the input datum D and the additional datum D″ are appropriate.

The second exemplary embodiment allows the machining engineer to recognize the appropriate additional datum D″. This allows the design engineer or other engineers to use the set additional datum D″ as is or reset the datum D by referencing the additional datum D″.

If a first additional datum D″ is set but determined to be inappropriate in the second exemplary embodiment, additional datums D″ are successively set until no further surface is available, and the controller determines whether the datums D and D″ are appropriate or not.

The exemplary embodiments of the present invention have been described. The present invention is not limited to the exemplary embodiments, and a variety of modifications are made within the scope of the present invention defined by the claims. Modifications 1 through 7 of the exemplary embodiments of the present invention are described below.

### Modification 1

In each of the exemplary embodiments, the outer periphery points G and G′ of the convex inclusion shape are extracted in accordance with the locations P′ and Q′ to which the end points P and Q of the boundary line of the surfaces and the predetermined quarter points Q are projected. The present invention is not limited to this method. For example, plural points P and Q are set at predetermined space intervals along a curved boundary line and the outer periphery points G and G′ are extracted in accordance with locations P′ and Q′ that more accurately reflect a shape approximation of the curved boundary line. Alternatively, the boundary line rather than the point may be projected, and a line serving as an outer periphery may be extracted from the projected boundary line to form a convex inclusion shape.

### Modification 2

In each of the exemplary embodiments, the outer periphery points G and G′ of the convex inclusion shape are extracted in accordance with all the locations P′ and Q′ to which the end points P and Q of the boundary line of the surface and the predetermined quarter points Q are projected. The present invention is not limited to this method. For example, if the locations P′ and Q′ is closer to each other than a predetermined spacing, the outer periphery points may be extracted with one of the locations decimated. In other words, the calculation process may be performed with the number of locations reduced.

The convex inclusion shape in the context of the specification may refer to a shape that is formed by wrapping with a rubber band a projection shape into which the surfaces A1 through An are projected, a polygon circumscribing the projection shape, or a shape approximating the projection shape.

### Modification 3

In each of the exemplary embodiments, the area S1 of the entire region R1 and the area S2 of the datum region R2 are desirably based on the area responsive to the convex inclusion shape, but may be the area of the maximum dimensional external shape or the projection area.

### Modification 4

In each of the exemplary embodiments, a determination as to whether the datum D is appropriate or not is based on whether the area ratio S2/S1 is higher than a constant threshold value. The present invention is not limited to this method. For example, the datum determination may be carried out by using a different threshold value. For example, the user may input a threshold value, or may select one from plural threshold values.

### Modification 5

In each of the exemplary embodiments, a circle is used as the datum D if the datum D is set in part of a surface. The present invention is not limited to a circle. The datum D may be set in any form, for example, a rectangle or a spot.

### Modification 6

In each of the exemplary embodiments, the magnitude of the area of the second region to the area of the first region is an area ratio. The magnitude may be represented by a difference between the areas.

### Modification 7

In the second exemplary embodiment, the determination process of datum is terminated if the datum D is not yet set. The present invention is not limited to this method. For example, if the datum D is not yet set, the additional datum D″ may be set, followed by the determination of the additional datum D″. In such a case, one of the surfaces Al through An having the largest area may be set to be the additional datum D″, followed by the datum determination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A determination system determining a measurement standard, comprising:
a memory that stores information concerning a three-dimensional shape of a produced workpiece and the measurement standard that is set in a surface forming the workpiece in response to a location where the workpiece is supported when a length of the workpiece is measured;
a calculating unit that calculates, in an projection plane perpendicular to a line normal to the surface having the measurement standard set thereon, an area of a first region that is based on an external shape of a projection image of the entire workpiece, and an area of a second region that is based on only a projection image of the surface having the measurement standard set thereon; and
a determining unit that determines that the measurement standard is appropriate if a magnitude of the area of the second region to the area of the first region is higher than a predetermined threshold value.

2. The determination system according to claim 1, wherein the memory stores the measurement standard that is determined in accordance with part of the surface forming the workpiece.

3. The determination system according to claim 1, further comprising a setting unit that sets a second measurement standard that is based on part different from the surface having the measurement standard set thereon, wherein a magnitude of the area of the second region that is based on the projection image of the surface having the measurement standard and a projection image of a surface having the second measurement standard set thereon to the area of the first region is higher than the predetermined threshold value.

4. The determination system according to claim 2, further comprising a setting unit that sets a second measurement standard that is based on part different from the surface having the measurement standard set thereon, wherein a magnitude of the area of the second region that is based on the projection image of the surface having the measurement standard and a projection image of a surface having the second measurement standard set thereon to the area of the first region is higher than the predetermined threshold value.

5. The determination system according to claim 1, further comprising a region setting unit that sets the first region that is responsive to a convex polygon including the projection image of the workpiece, the convex polygon based on the external shape of the projection image of the workpiece, and sets the second region that is responsive to a convex polygon including the measurement standard, the convex polygon based on only the projection image of the surface having the measurement standard.

6. The determination system according to claim 2, further comprising a region setting unit that sets the first region that is responsive to a convex polygon including the projection image of the workpiece, the convex polygon based on the external shape of the projection image of the workpiece, and sets the second region that is responsive to a convex polygon including the measurement standard, the convex polygon based on only the projection image of the surface having the measurement standard.

7. The determination system according to claim 3, further comprising a region setting unit that sets the first region that is responsive to a convex polygon including the projection image of the workpiece, the convex polygon based on the external shape of the projection image of the workpiece, and sets the second region that is responsive to a convex polygon including the measurement standard, the convex polygon based on only the projection image of the surface having the measurement standard.

8. The determination system according to claim 4, further comprising a region setting unit that sets the first region that is responsive to a convex polygon including the projection image of the workpiece, the convex polygon based on the external shape of the projection image of the workpiece, and sets the second region that is responsive to a convex polygon including the measurement standard, the convex polygon based on only the projection image of the surface having the measurement standard.

9. A determination method determining a measurement standard, comprising:
storing information concerning a three-dimensional shape of a produced workpiece and the measurement standard that is set in a surface forming the workpiece in response to a location where the workpiece is supported when a length of the workpiece is measured;
calculating, in a projection plane perpendicular to a line normal to the surface having the measurement standard set thereon, an area of a first region that is based on an external shape of a projection image of the entire workpiece, and an area of a second region that is based on only a projection image of the surface having the measurement standard set thereon; and
determining that the measurement standard is appropriate if a magnitude of the area of the second region to the area of the first region is higher than a predetermined threshold value.

10. A non-transitory computer readable medium storing a program causing a computer to execute a process for determining a measurement standard, the process comprising:
storing information concerning a three-dimensional shape of a produced workpiece and the measurement standard that is set in a surface forming the workpiece in response to a location where the workpiece is supported when a length of the workpiece is measured;
calculating, in a projection plane perpendicular to a line normal to the surface having the measurement standard set thereon, an area of a first region that is based on an external shape of a projection image of the entire workpiece, and an area of a second region that is based on only a projection image of the surface having the measurement standard set thereon; and
determining that the measurement standard is appropriate if a magnitude of the area of the second region to the area of the first region is higher than a predetermined threshold value.
